(19) United States
(12) Patent Application Publication
(10) Pub. No.: US 2025/0272962 A1
(43) Pub. Date: Aug. 28, 2025

(54) Systems, Methods, and Apparatuses for Anatomically Consistent Embeddings in Composition and Decomposition

(71) Applicant: Arizona Board of Regents on behalf of Arzona State University, Scottsdale, AZ (US)

(72) Inventors: Ziyu ZHOU, Shanghai (CN); Haozhe LUO, Zurich (CH); Jiaxuan PANG, Tempe, AZ (US); DongAo MA, Tempe, AZ (US); Jianming LIANG, Scottsdale, AZ (US)

(73) Assignee: Arizona Board of Regents on behalf of Arizona State University, Scottsdale, AZ (US)

(21) Appl. No.: 19/057,881

(22) Filed: Feb. 19, 2025

Related U.S. Application Data
(60) Provisional application No. 63/558,040, filed on Feb. 26, 2024.
(60) Provisional application No. 63/670,543, filed on Jul. 12, 2024.

(51) Int. Cl. G06V 10/774; G06V 10/10; G06V 10/26; G06V 10/32; G06V 10/82; G06V 20/69

(52) U.S. Cl. CPC G06V 10/7753; G06V 10/16; G06V 10/26; G06V 10/32; G06V 10/82; G06V 20/695; G06V 2201/03

(57) ABSTRACT

A method performed by a system having at least a processor and a memory therein to execute instructions for a self-supervised learning framework to learn anatomically consistent embeddings of anatomical structures in medical images of a plurality of patients across varying scales of anatomical structures in the plurality of patients receives a medical image as an input, and obtains a first cropped image and a second overlapping cropped image of the received medical image, each having respective representative global embeddings and corresponding overlapped patch embeddings and non-overlapped patch embeddings. The system calculates a global consistency loss using the respective representative global embeddings and calculates a local consistency loss using the corresponding overlapped patch embeddings and non-overlapped patch embeddings.

### CLAIM OF PRIORITY

This application claims the benefit of U.S. Provisional Patent Application No. 63/558,040, filed Feb. 26, 2024, entitled “SYSTEMS, METHODS, AND APPARATUSES FOR ANATOMICALLY CONSISTENT EMBEDDINGS IN COMPOSITION AND DECOMPOSITION”, the disclosure of which is incorporated by reference herein in its entirety, and claims the benefit of U.S. Provisional Patent Application No. 63/670,543, filed Jul. 12, 2024, entitled “ANATOMICALLY CONSISTENT EMBEDDINGS VIA COMPOSITION AND DECOMPOSITION”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of the disclosure of this patent document contains material which is subject to copyright protection. The copyright owner has no objection to the facsimile reproduction by anyone of the disclosure as it appears in the Patent and Trademark Office patent file or records, but otherwise reserves all copyright rights whatsoever.

### TECHNICAL FIELD

Embodiments of the invention relate to a self-supervised learning (SSL) framework optimized for hierarchical and multi-scale consistency in discerning and deconstructing spatial relationships between anatomical structures and their sub-structures in medical images of patients.

### BACKGROUND

Self-supervised learning (SSL) is an approach used in training machine learning models without extensive expert annotations, which is an advantage in medical imaging where expert labeling is costly and labor-intensive. SSL, as an alternative, reduces dependence on annotated datasets and lowers annotation expenses.

Photographic images typically feature central, object-centric themes set against varied backgrounds. SSL techniques designed for these images primarily focus on foreground elements. The recent SSL methods, mainly designed for photographic images, do not fully exploit the inherent characteristics of medical images. Medical images (e.g., chest X-rays), unlike photographic images with target objects typically at the center on varying backgrounds, showcase consistent, global (lung, heart) and local (clavicle, bronchus) anatomical structures, resulting from standardized imaging protocols. In addition, from an anatomical point of view, organs or tissues are decomposable, such as the left lung consisting of the superior lobe and the inferior lobe. To utilize these medical priors it is hypothesized that simultaneously learning from global and local consistencies via composition and decomposition can equip a machine learning model to understand the anatomy, thereby offering strong transferability. Furthermore, in contrast to SSL techniques, medical imaging presents a unique set of characteristics, distinct from the photographic domain. The consistency of anatomical structures in medical images, as illustrated in FIGS. 1A and 1B, results from standardized imaging protocols. FIG. 1A shows that different chest X-rays with large variations in terms of patient weights share consistent anatomical patterns but exhibit diverse appearances in scales as indicated by the dotted landmarks 100. Moreover, diseases like cardiomegaly and atelectasis show a multi-scale appearance across patients of different weights and ages. For these reasons, classifying anatomical patterns and diseases needs the model to be equipped with the ability to discriminate multi-scale consistency among different patients. FIG. 1B shows the hierarchical nature of anatomy (e.g., the left lung has two lobes, the superior lobe x, at 105, and the inferior lobe y, at 110) and calls for anatomical representation with compositionality where the embedding of the whole patch should be the sum of the embeddings of each part. This has motivated the development of the disclosed embodiment, referred to herein as the Anatomically Consistent Embeddings (ACE) framework (FIG. 2) with multi-scale grid-wise cropping (FIGS. 3A and 3B). This consistency introduces a different challenge: the need to detect not only the salient “foreground” anomalies, such as pathological features, but also to develop a nuanced understanding of the “background”—the intricate tapestry of anatomy. The uniformity in anatomical representations, further depicted in FIG. 1B, emphasizes the hierarchical and decomposable nature of medical images. This necessitates the ability to distinguish various anatomical and pathological entities within this context, an aspect that is often less emphasized in the analysis of photographic images. For instance, in thoracic imaging, analysis goes beyond recognizing macrostructures like pulmonary lobes, cardiac silhouette, or diaphragmatic contour. It involves dissecting finer anatomical components such as bronchovascular markings, segmental lung fields, or trabecular patterns of osseous structures. Each element carries unique anatomical significance and may indicate localized pathological processes. The ability to discern and characterize these components individually, within the larger anatomical context, is useful for comprehensive medical image evaluations.

The distinction between photographic and medical imaging prompts the question how can self-supervised learning (SSL) be refined for hierarchical and multi-scale consistency in discerning and deconstructing the spatial relationships between anatomical structures and their sub-structures? This issue is significant for chest radiographs due to the diversity of anatomical structures they display. The disclosed embodiments employ effective strategies for SSL to autonomously assimilate the subtle interplay of global anatomical structures and localized pathological changes inherent in medical images.

Self-supervised learning (SSL) methods share a common goal of learning meaningful representations without labeled data but differ in their primary learning focus: global features, local features, or structural patterns within images.

Learning global features. A significant strand of SSL research concentrates on learning global features from images. These methods aim to extract features that capture the overall context of the image, encouraging consistency and alignment across various transformed versions of the input data. These methods can be grouped into two categories including contrastive learning and non-contrastive learning methods. This strand of research has progressively evolved to address challenges such as avoiding collapsing solutions and ensuring a balanced representation of global image features. However, these methods typically excel in capturing the consistency of macro-structures and are particularly effective for images with prominent foregrounds, but they often fail to capture the complexity of local details. This is especially evident in medical imaging, where the richness of detailed textures and the precise spatial relationships between anatomical structures are paramount. In such contexts, important details can be overlooked, compromising the granularity necessary for accurate medical analysis.

Learning local features. Another research thread focuses on local feature learning whose objective is to distill fine-grained information by zooming in on specific parts of the image. This could involve detailed analysis of pixel-level features or segmenting images into smaller, coherent regions to learn representations that honor the local semantic content of the visual input. Prior art approaches utilize local features by computing embedding consistency or contrastive learning loss considering the relative positions of the features, such as the feature vectors of patches that are semantically closest or spatially nearest neighbors. However, in these ways the local patch embeddings may not be precisely paired which will confuse the model. By contrast, the disclosed embodiments of models described hereinbelow learn local features shown in FIG. 2, at least by utilizing composition and decomposition of grid-wise overlapped patch matching. Through learning precise local consistency, the models are encouraged to capture fine-grained presentations that are more discriminative for segmenting and classifying diseases in medical images.

Learning structural patterns. A third avenue within SSL is the exploration of structural patterns. These methods parse the image to understand and leverage the inherent structural regularities and contextual relationships between different image parts. They involve both convergence of global and local features, offering a more comprehensive approach to feature extraction, but still cannot efficiently bridge the relationship between the wide image context with specific details. Advancements in SSL also include novel auxiliary tasks and augmentations, pushing the boundaries of feature learning. These enhancements are crafted to prompt models to learn more generalizable and distinctive features. However, these methods often concentrate only on macro-structures, for instance, by setting proxy tasks such as predicting the relative positions of different patches, determining the angles of rotated images, or inferring the jigsaw position of shuffled image segments, which may disregard the finer, yet critical, structural consistencies and the subtle spatial relationships within tissues. The embodiments described hereinbelow bridge this gap at least by utilizing the consistency of global patterns and composition, alongside the decomposition, of local patterns, resulting in a hierarchical and integrative feature embedding structure.

### BRIEF DESCRIPTION OF THE DRAWINGS

Embodiments are illustrated by way of example, and not by way of limitation, and can be more fully understood with reference to the following detailed description when considered in connection with the figures in which:

FIGS. 1A and 1B illustrate different chest X-rays with large variations in terms of patient weights that share consistent anatomical patterns but exhibit diverse appearances in scales.

FIG. 2 illustrates a diagram of embodiments of the invention.

FIGS. 3A and 3B illustrate a grid-wise multi-scale image cropping method according to embodiments.

FIG. 3C presents Table 1 corresponding to the illustrations in FIGS. 3A and 3B.

FIGS. 4A and 4B illustrate visualization of weakly-supervised disease localization via Grad-CAM for BYOL vs. ACE′ and for POPAR vs. ACE′.

FIGS. 5A and 5B illustrate examples of image registration results in accordance with embodiments of the invention.

FIGS. 6A and 6B illustrate an enhanced image retrieval process in accordance with embodiments of the invention.

FIGS. 7A and 7B illustrate learning composable embeddings in accordance with embodiments of the invention.

FIG. 8 illustrates an enhanced feature decompositionality process in accordance with embodiments of the invention.

FIGS. 9A, 9B, 9C and 9D illustrate an enhanced model for generating a more distinct embedding space of anatomical structure in accordance with embodiments of the invention.

FIG. 10 illustrates t-SNE of symmetrical anatomies in accordance with embodiments of the invention.

FIG. 11 presents Table 2, which compares the disclosed embodiments with other self-supervised methods.

FIG. 12 presents Table 3, which shows the individual effects of components of the disclosed embodiments: (a) global consistency (“L_{global}” column), (b) contrastive learning (“L_{contrastive}” column) and (c) corresponding matrix matching (“Lₘₐₜᵣᵢₓ” column).

FIG. 13 depicts learning anatomical embedding with global and local consistencies in accordance with embodiments of the invention.

FIGS. 14A and 14B depict learned properties of feature compositionality in accordance with embodiments of the invention.

FIG. 14C depicts decompositionality in accordance with embodiments of the invention.

FIG. 14D depicts image retrieval according to embodiments of the invention.

FIG. 15 depicts embodiments that provide more precise weakly-supervised disease localization.

FIG. 16A depicts embodiments that provide superior performance on linear probing.

FIG. 16B depicts data efficiency in embodiments of the invention.

FIG. 16C depicts pretrained ACE applied to classification, segmentation and key point detection tasks with the chosen key points according to embodiments of the invention.

FIGS. 16D and 16E depict key point comparison and detection evaluation according to embodiments of the invention.

FIG. 17 presents Table 4 in which performances are compared with models, according to the disclosed embodiment, training from scratch and other self-supervised pretraining methods.

### DETAILED DESCRIPTION

Described herein are systems, methods, and apparatuses for a self-supervised learning (SSL) framework optimized for hierarchical and multi-scale consistency in discerning and deconstructing spatial relationships between anatomical structures and their sub-structures in medical images of patients.

Precise diagnosis in medical imaging hinges on thoroughly analyzing image features, from macroscopic anatomical patterns to microscopic textural details, hierarchical (top-down and bottom-up) and integrative features, but existing self-supervised learning methods, mostly designed for photographic images, do not appreciate such hierarchical structure attributes inherent to medical images. To overcome this limitation, the disclosed embodiments employ a novel approach referred to herein as Anatomically Consistent Embeddings (ACE) to learn anatomically consistent embeddings, seeking to capture hierarchical features consistent across varying scales, from subtle disease textures to structural anatomical patterns. The embodiments leverage the intrinsic properties of medical images (e.g., composition, decomposition), bridge the semantic gap across scales from high-level pathologies to low-level tissue anomalies, and ensure a seamless integration of fine-grained details with global anatomical structures in a hierarchical fashion. Experimental results confirm the superior performance of the embodiments in terms of feature representation, disease classification, and segmentation, setting a new benchmark for chest radiography interpretation.

To utilize the properties of chest radiology, embodiments learn composition and decomposition of anatomy for anatomically consistent embeddings, thereby harnessing representations that seamlessly integrate from local to global embeddings. This framework is tailored to ensure consistency of multi-scale features and is focused on modeling the inherent associations between anatomical patterns at varying scales, from granular textures to overarching structures. Development of the disclosed embodiments and this description provide at least the following contributions:
an effective SSL approach that achieves hierarchical and multi-scale consistency through reliable composition and decomposition methods in medical imaging;
a set of experiments that demonstrates the transferability of ACE to various target tasks, outperforming state-of-the-art SSL methods in classification and segmentation; and
extensive findings that show the capabilities of the pre-trained model in image registration, image retrieval, composition, decomposition, and interpretation.

An objective of embodiments of the invention is learning ACE of anatomical structures inside medical images. In medical images, there are various global and local anatomies such as organs including lung, heart and hemidiaphragm and diseases like nodule and cardiomegaly.

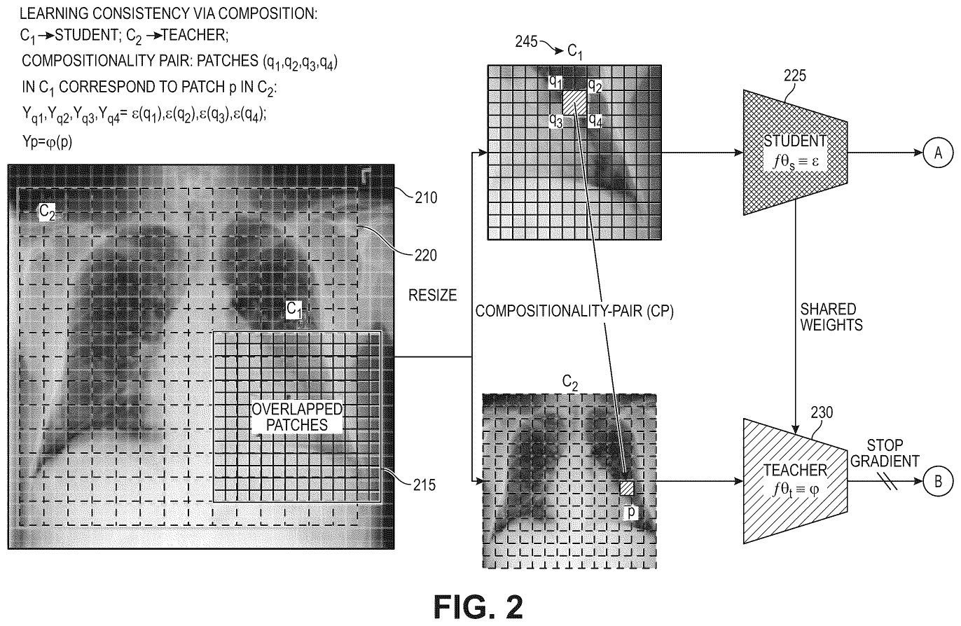

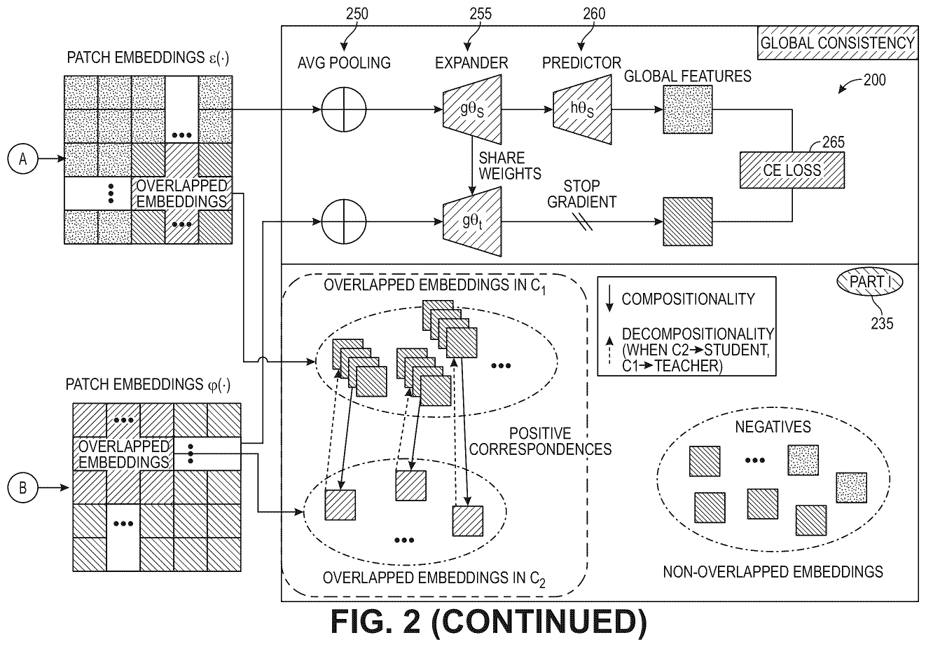

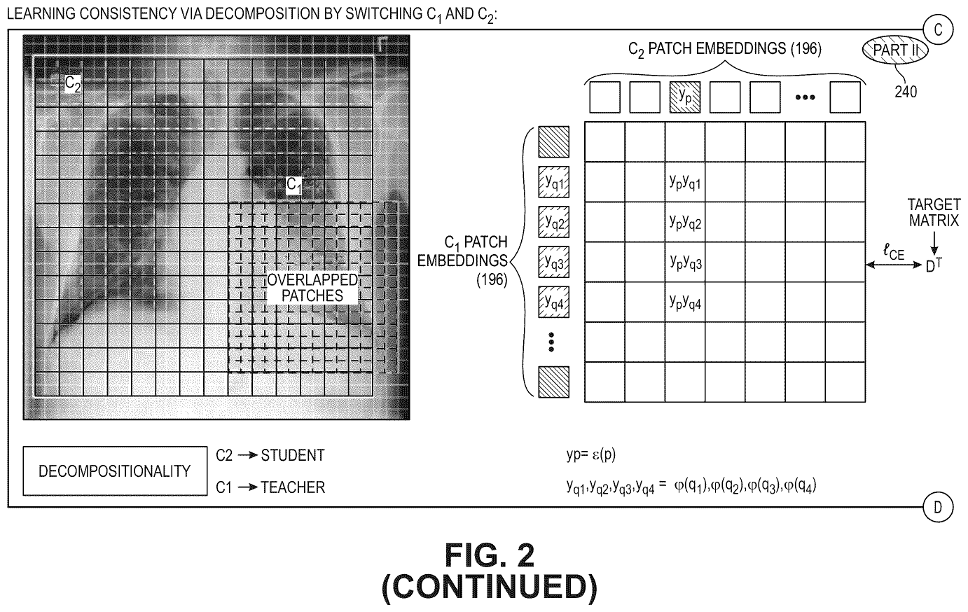

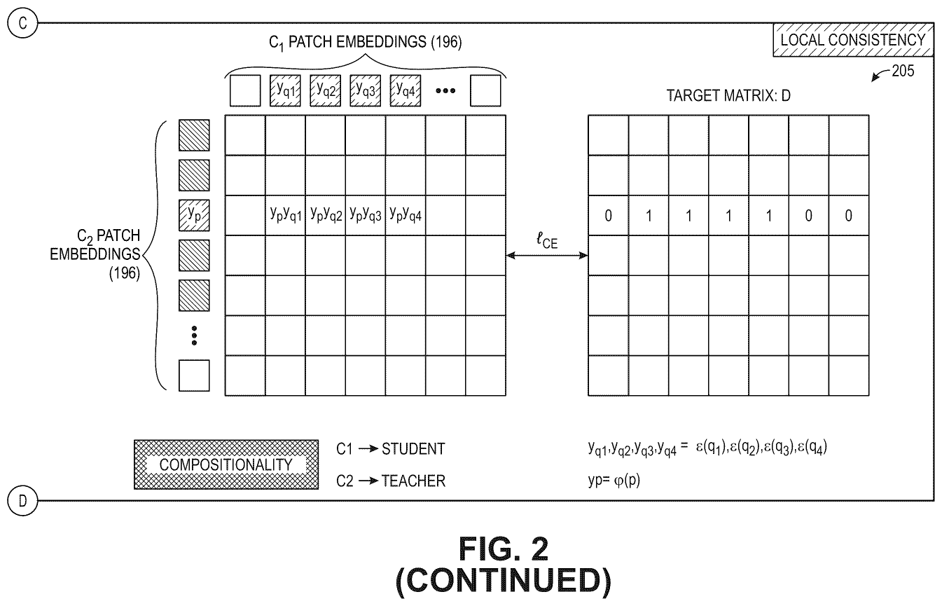

FIG. 2 illustrates the ACE framework, according to one disclosed embodiment, consisting of two constituents: global consistency 200 and local consistency 205. Taking two crops C₁ 215 and C₂ 220 from an initial image 210, their representative global embeddings are utilized to optimize the global consistency loss, and the correspondent overlapped patch embeddings and the non-overlapped patch embeddings are used to calculate local consistency loss. The local consistency loss has two terms: contrastive learning loss and corresponding matrix matching loss. If C₁ and C₂ are input to a student model 225 and a teacher model 230 respectively, for the contrastive loss shown in Part I 235, the four overlapped patches (q₁, q₂, q₃, q₄) compose one corresponding patch (p) hence the composition-pair patches are positive pairs and the non-overlapped patches are negative pairs. And for the corresponding matrix matching shown in Part II 240, composition denotes that correlations between one to four corresponding patches should be close to one while the others should be zero. Symmetrically, inputting C₂ and C₁ to both the student and teacher branches learns decomposition for local consistency.

As illustrated in FIG. 2, according to one disclosed embodiment, by learning these global and local patterns, two constituents are introduced into a method, according to embodiments, which are as follows: (1) global consistency 200 encourages the network to extract high-level semantic features of similar global regions, (2) local consistency 205 enforces the model to understand fine-grained local patterns via composition and decomposition. By integrating these components into a unified framework, ACE captures multi-scale and hierarchical information in medical images, which provides more powerful representations for various downstream tasks. The following description introduces methods from image pre-processing.

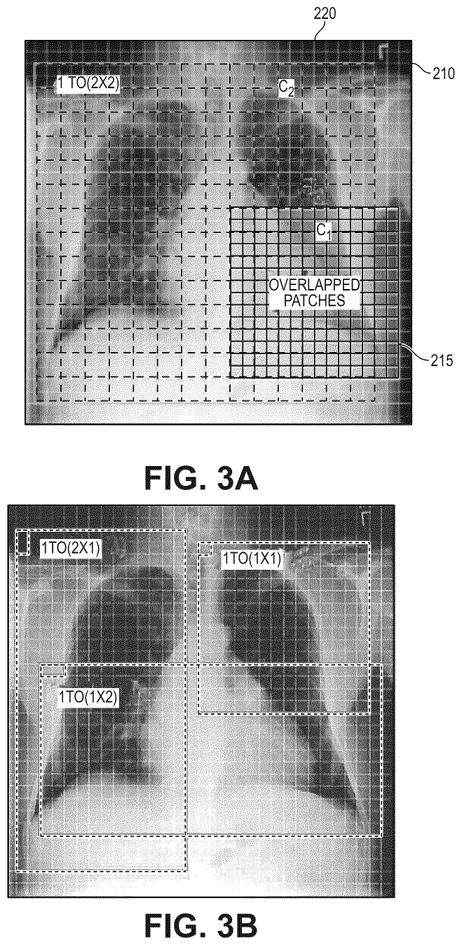

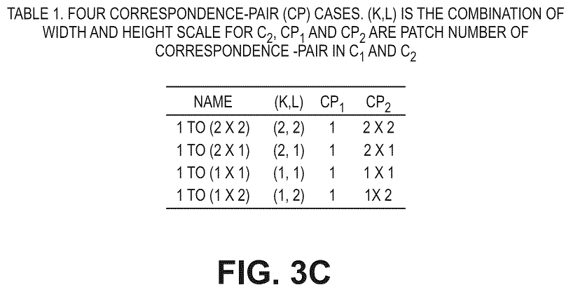

Image pre-processing. Image pre-processing comprises grid-wise multi-scale image cropping. To get random size and scale image crops, a novel grid-wise multi-scale image cropping method is employed according to embodiments. With reference to the multi-scale grid-wise cropping illustrated in FIGS. 3A, 3B, and corresponding table in FIG. 3C, FIG. 3A depicts the sizes of C₁ 215 and C₂ 220 are (14×m)×(14×m) and (28×m)×(28×m) where a patch in C₂ 220 corresponds to four patches in C₁ 215, hence the name “1 to (2×2)”. The rest of the cases in Table 1 presented in FIG. 3C are shown in FIG. 3B. As shown in FIG. 3A, the initial image 210 is gridded to 180 (32×m)×(32×m), where m is the size of each grid. C₂ 220 is randomly cropped from the initial image 210 with size of [14×(k×m)]×[14×(l×m)], where k, 1∈{1, 2}. And the beginning of C₂ is the grid node. For C₁ 215, the size is fixed to (14×m)×(14×m) whose beginning is the node of C₂. If k, l=2, as shown in FIG. 3A, the sizes of C₂ and C₁ are (28×m)×(28×m) and (14×m)×(14×m) respectively, and for the overlapped patches, each patch in C₂ corresponds to four patches in C₁. The four correspondence-pair (CP) cases are listed in Table 1.

Learning global consistency. After grid-wise multi-scale image cropping, the two crops are resized at 245 to the same shape C₁, C₂∈R^{C×H0×W0}, C is the image channel and H₀, W₀ are the height and width of the input crops. The resized crops C₁ and C₂ are input to Student model f_{θs} 225 and Teacher model f_{θt} 230 to get patch embeddings yₛ, yₜ=f_{θs} (x), f_{θt} (x′)∈R^{D×H×W} respectively. Then the average pooling operator ⊕ 250 is added to the last two dimensions to get global embeddings y_{s⊕}, y_{t⊕}∈R^{D} which represent the whole images. The expanders depicted at 255, g_{θs}, g_{θt} are utilized to expand dimensions of the global embeddings y′_{s⊕}, y′_{t⊕}∈R^{H}. At last, a predictor, h_{θs} depicted at 260 is inserted to the student branch to predict the embedding of teacher branch: y″_{s⊕}=h_{θs}(y′_{s⊕})∈R^{H}. Cross-entropy loss 265 is minimized to constrain the global consistency shown in Eq. 1:

$${ℒ}_{global} = CE ( {y}_{s ⊕}^{″} , {y}_{t ⊕}^{′} ) \qquad ( 1 )$$

Learning local consistency in composition and decomposition. Intuitively, the embedding of a whole image should be equal or close to the sum of the embeddings of each of its parts. Consequently, compositionality in learning local features is defined as:

$${f}_{{θ}_{t}} ( p ) \approx \frac{1}{4} ( {f}_{{θ}_{s}} ( {q}_{1} ) + {f}_{{θ}_{s}} ( {q}_{2} ) + {f}_{{θ}_{s}} ( {q}_{3} ) + {f}_{{θ}_{s}} ( {q}_{4} ) ) \qquad ( 2 )$$

where p is an overlapped patch in C₂ corresponding to four overlapped patches q₁, q₂, q₃, q₄ in C₁ shown in FIG. 2, Part I 235. For C₁ patch embeddings set in student branch K^{(s)}={yₛ₁, yₛ₂, . . . , y_{sHW}}∈R^{D} and C₂ patch embeddings in teacher branch K^{(t)}={yₜ₁, yₜ₂, . . . , y_{tH}}∈R^{D}, the overlapped patch embeddings sets O^{(s)}={yₛ₁, yₛ₂, . . . , yₛₘ} and O₍ₜ₎={yₜ₁, yₜ₂, . . . , yₜₙ} are subsets of K^{(s)} and K^{(t)}, where m and n are the numbers of overlapped patches for C₁ and C₂ and m=4n in the case of FIG. 2. The rest non-overlapped patch embeddings sets are N^{(s)}={yₛ₁, yₛ₂, . . . , y_{sHW-m}}=K^{(s)}−O^{(s)} and N^{(t)}={yₜ₁, yₜ₂, . . . , y_{tHW-n}}=K^{(t)}−O^{(t)}.

The overlapped paired patches in C₁ and C₂ should be regarded as positive pairs and the rest non-overlapped patches are negative pairs. To learn composition, C₁ is input to student and C₂ is input to teacher, the four overlapped patch embeddings in student branch are averaged composing to one overlapped patch in teacher branch, accordingly the overlapped patch embeddings set in student branch are O^{(s)}={y_{s1⊕}, y_{s2⊕}, y_{sn4⊕}}, where y_{sk⊕} is the average embedding of every four overlapped embeddings, whose elements may be one-to-one corresponding with elements in O^{(t)}. At last, InfoNEC is defined for contrastive learning loss to learn patch level local consistency via composition:

$${ℒ}_{contrastive} = - log \frac{{e}^{( q \cdot {k}_{+} / τ )}}{{\sum }_{i = 1}^{N} {e}^{( q \cdot {k}_{i} / τ )}} \qquad ( 3 )$$

where q is the query patch embeddings in O^{(s)}, k+ is the corresponding positive embedding in O^{(t)} and N is the overall number of patch embeddings in a mini-batch which contains overlapped and non-overlapped patch embeddings. Symmetrically, C₂, C₁ are input to student and teacher branches to learn local consistency in decomposition. As shown in FIG. 2 Part I 235, a patch embedding from C₂ can be decomposed into four embeddings from C₁. The loss writing form of learning decomposition is the same with Eq. 3.

Learning local consistency by corresponding matrix matching. For the overlapped patches in the two crops, the embeddings of paired patches should be consistent. Therefore, the similarity of the paired patch embeddings is maximized and the unpaired is minimized. A clip like matrix is constructed to drive the model to learn this consistency as shown in FIG. 2 Part II 240.

To learn consistency via composition, C₁ is input to student and C₂ to teacher model, which yields K=H×W embeddings for each crop: \hat{ }yₛ, \hat{ }yₜ∈R^{D×K}, where D is the dimension of each embedding. The cross-correlation matrix is defined as:

$$P = sigmoid ( {\hat{y}}_{s}^{T} \cdot {\hat{y}}_{t} ) \qquad ( 4 )$$

where P∈R^{K×K}, T is the transformation of a matrix, (·) is matrix multiplication, the sigmoid function is added to restrict the values of the matrix to (0, 1). The overlapped patch indexes for C₁ and C₂:idx⁽¹⁾, idx⁽²⁾∈R^{H×W,} and flatten the indexes to one line: id\hat{ }x⁽¹⁾, id\hat{ }x⁽²⁾∈R1×K, the values in these two indexes can be described as:

$$i \hat{d} {x}_{i}^{( 1 )} , i \hat{d} {x}_{i}^{( 2 )} = \{ \begin{matrix}1 , & if i ∈ overlapped \\ 0 , & if i ∈ non - overlapped\end{matrix} \qquad ( 5 )$$

The cross-correlation matrix is calculated as the target matrix [symbol] ∈R^{K×K}:

$$Q = i \hat{d} {x}^{( 1 ) T} \cdot i \hat{d} {x}^{( 2 )} \qquad ( 6 )$$

The focal CE loss is used to get close to the embedding correlation matrix P and index correlation matrix [symbol] :

$${ℒ}_{matrix}^{comp} = ( α \cdot Q + ( 1 - α ) \cdot ( 1 - Q ) ) \cdot CE ( P , Q ) \qquad ( 7 )$$

where the hyper-parameter α is used to balance the positive and negative samples. Take 1 to 2×2 as an example (one case shown in Table 1 of FIG. 3C), 4 patches in C₁ correspond to 1 patch in C₂ which results only in four positive samples in a row shown in FIG. 2 Part II 240. CE(P, [symbol] ) means cross-entropy loss between P and [symbol] .

Symmetrically, C₂ and C₁ are input to student and teacher branches for learning decomposition. In this case, the target matrix is transposed as [symbol] ^{T}, and the decomposition loss is:

$${ℒ}_{matrix}^{decomp} = ( α \cdot {Q}^{T} + ( 1 - α ) \cdot ( 1 - {Q}^{T} ) ) \cdot CE ( P , {Q}^{T} ) \qquad ( 8 )$$

The corresponding matrix loss is Lₘₐₜᵣᵢₓ=(L^{comp}ₘₐₜᵣᵢₓ+L^{decomp}ₘₐₜᵣᵢₓ)/2. Finally, the total loss is defined in Eq. 9, where L_{global} is the global consistency loss, L_{contrastive} and Lₘₐₜᵣᵢₓ are two terms of local consistency loss. The L_{global} empower the model to learn coarse-grained anatomical structure from global patch embeddings. L_{contrastive} and Lₘₐₜᵣᵢₓ equip the model to learn precisely fine-grained local anatomical structures in composition and decomposition.

$$ℒ = {ℒ}_{global} + {ℒ}_{contrastive} + {ℒ}_{matrix} \qquad ( 9 )$$

Thus, according to embodiments, a system having at least a processor and a memory therein to execute instructions provides a self-supervised learning framework to learn anatomically consistent embeddings of anatomical structures in medical images of a plurality of patients across varying scales of anatomical structures in the plurality of patients. The executable instructions include receiving a medical image as an input, obtaining a first cropped image and a second overlapping cropped image of the received medical image, each having respective representative global embeddings and corresponding overlapped patch embeddings and non-overlapped patch embeddings, calculating a global consistency loss using the respective representative global embeddings, and calculating a local consistency loss using the corresponding overlapped patch embeddings and non-overlapped patch embeddings.

According to embodiments, calculating the local consistency loss using the corresponding overlapped patch embeddings and non-overlapped patch embeddings involves calculating a contrastive learning loss and a corresponding matrix matching loss.

According to embodiments, calculating the contrastive learning loss involves receiving the first and second cropped images at respective student and teacher networks of the self-supervised learning framework. According to embodiments, the first cropped image contains four overlapped patch embeddings that correspond to the patch embedding in the second cropped image, to yield a compositionality-pair of patches that are positive and non-overlapped patches that are negative.

According to embodiments, calculating the corresponding matrix matching loss involves receiving the first and second cropped images at respective teacher and student networks of the self-supervised learning framework to learn decompositionality for local consistency. In these embodiments, obtaining the first cropped image and the second overlapping cropped image of the received medical image, each having respective representative global embeddings and corresponding overlapped patch embeddings and non-overlapped patch embeddings, includes the steps of organizing the medical image into a two-dimensional grid of image elements (“patches”), randomly selecting a first plurality of the patches in the two-dimensional grid to obtain the first cropped image, selecting a second plurality of patches in the two-dimensional grid that overlap, and are a multiple of, the first plurality of patches to obtain the second cropped image, and resizing the first cropped image and the second cropped image to a same shape. In these embodiments, obtaining the first cropped image and the second overlapping cropped image of the received medical image, each having respective representative global embeddings and corresponding overlapped patch embeddings and non-overlapped patch embeddings, further includes the steps of receiving the resized first and second cropped images at respective student and teacher networks of the self-supervised learning framework and generating respective patch embeddings therefrom, and receiving the respective patch embeddings at respective average pooling operators and generating the respective representative global embeddings therefrom. According to these embodiments, obtaining the first cropped image and the second overlapping cropped image of the received medical image, each having respective representative global embeddings and corresponding overlapped patch embeddings and non-overlapped patch embeddings, further involves receiving the respective representative global embeddings at respective student and teacher expanders to expand dimensions of the respective representative global embeddings. Finally, in these embodiments, obtaining the first cropped image and the second overlapping cropped image of the received medical image, each having respective representative global embeddings and corresponding overlapped patch embeddings and non-overlapped patch embeddings, further involves receiving the expanded representative global embedding from the student expander at a predictor in the student network to the representative global embedding of the teacher network.

### Implementations Details

Pretraining settings. The above disclosed embodiment of the invention is referred to as ACE and contains the matrix matching component and local contrastive learning component to learn the composition and decomposition. Another embodiment, a prime version, called ACE′, is consistent with the global consistency loss shown above, which is based on DINO's global consistency component as global information learner. Embodiments pretrain ACE′ from scratch on unlabeled ChestX-ray14 dataset with Swin-B and ViT-B backbones. The model is pretrained on an image size of 448×448 for 300 epochs. As for the expander of the architecture, a 3-layer convolution is used to expand the dimension and for the predictor head in the student branch, a 2-layer MLP is utilized to predict the output feature from the teacher branch. The weights of the student model are updated by back-propagation and the gradients of teacher model are stopped and whose weights are shared from the student model. To compare with a method according to embodiments of the invention, a variety of SSL methods developed for ResNet, Vision Transformer and Swin-Transformer architectures is used. And these methods respectively leverage global information: DINO, BYOL; patch-level information: SelfPatch; and the structural information of images: Adam, POPAR, DropPos. For equal comparison, the same experimental settings with the method and pretrain these methods with ChestX-ray14 dataset. More details are in the supplementary materials provided in the appendix attached hereto.

Target tasks and datasets. Embodiments pretrain models in a supervised setting on downstream tasks including classification and segmentation. Classification performance is validated on three thoracic disease classification tasks, ChestX-ray, Shenzhen CXR, and RSNA pneumonia. For segmentation tasks, dense prediction performance is validated on JSRT, ChestX-Det, SIIM-ACR and Montgomery. The pretrained models are transferred to each target task by fine-tuning the whole parameters. The AUC (area under the ROC curve) metric is utilized to assess the performance of multi-label classification tasks on datasets such as ChestX-ray14 and NIH Shenzhen CXR and for RSNA Pneumonia, accuracy is used as the evaluative measure. For the target segmentation task, the UperNet is used as the training model. An additional randomly initialized prediction head is added for segmenting and the Dice is used to evaluate the segmentation performance. More details are found in the supplementary materials provided in the attached appendix.

Results. To fully assess the properties of the framework, extensive experiments were conducted across quantitative metrics and qualitative indices, which could be divided into two categories: (a) testing the transferability of the pretrained model by transferring to target tasks shown below; (b) exploring the capabilities of the pretrained model itself including the potential for image registration, image retrieval, composition, decomposition and interpretability.

### ACE Shows Prominent Transferability for Downstream Tasks

Experimental setup: ACE′ is pretrained on Swin-B and Vit-B backbones, then transferred to downstream classification and segmentation datasets. To assess the method's superiority, the finetuning performances are compared with training from scratch and other self-supervised pretraining methods including DINO, BYOL, SelfPatch, Adam, DropPos and POPAR. All these methods are pretrained from medical X-ray dataset ChestX-ray14 and finetuned to seven other target tasks.

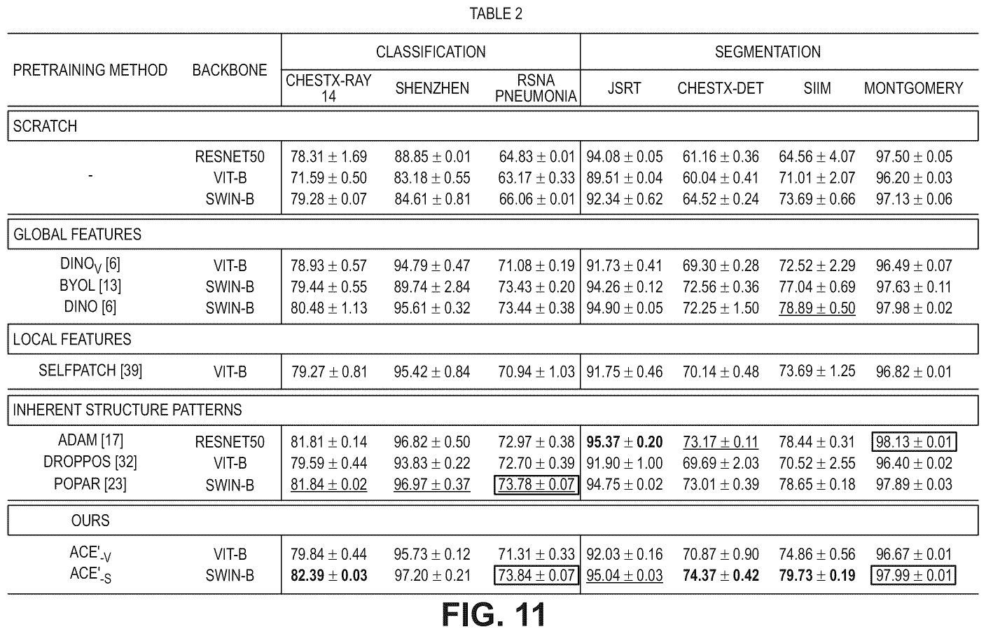

Results: Table 2, presented in FIG. 11, provides a comparison with other self-supervised methods. The best methods are in boldface type font and the second-best methods are underlined. Two independent sample t-tests were conducted between the best versus others. The four boxes in the table highlight when the tests are not significantly different.

As shown in Table 2, there are several observations: (a) the method surpasses the model training from scratch by a significant margin; (b) for the Swin-B backbone comparing with BYOL, DINO and POPAR, ACE's achieves the best performances among the seven target classification and segmentation datasets; (c) for the ViT-B backbone, the performances of ACE′-v outperform or are comparable among the ViT-B methods DINOv, SelfPatch and DropPos. These results show the transferability of the pretrained weights and demonstrate the effectiveness of learning consistent in composition and decomposition method according to embodiments of the invention.

### ACE Improves Weakly-Supervised Disease Localization

Experimental setup: The method according to embodiments is explored in a weakly-supervised learning setting, proving its capability to localize diseases for underlying discriminative methods. For this goal, the ChestX-ray14 dataset is used, which has 112,000 images with classification labels and 880 testing images containing bounding box annotations. In the training period, ACE's pretrained model is loaded as the initial weight and then finetune ChestX-ray14 using only image-level classification labels following the experimental setting described above. Following Grad-CAM, in the testing phase, heatmaps are generated which reflect the model discrimination regions and the bounding boxes are only used as ground truth to measure the accuracy of the model activation disease regions.

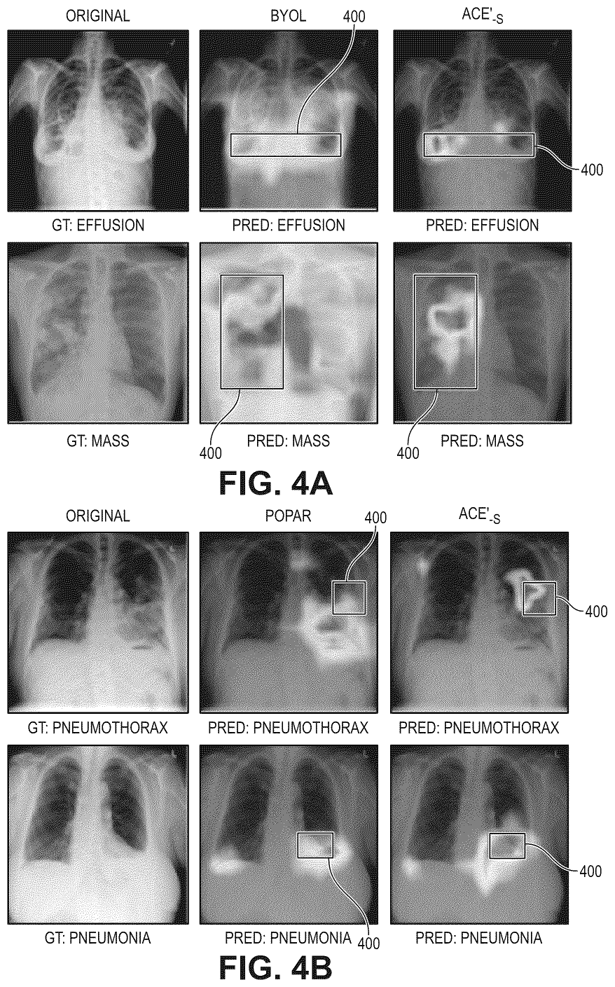

Results: FIGS. 4A and 4B illustrate visualization of weakly-supervised disease localization via Grad-CAM for BYOL vs. ACE′ and for POPAR vs. ACE′. The rectangular boxes 400 are official labeled disease ground truth. A method according to embodiments shows more precise localization while BYOL and POPAR attune to activate more coarse and bigger areas with shifts. As shown in FIG. 4, initializing with the pretrained method, the finetuning model can localize and discriminate disease more accurately. The comparison methods BYOL and POPAR are prone to generate variable and shifting heatmaps while the localizations of the method according to embodiments are more reliable, which can not only predict the true labels but precisely locate the diseases. From the interpretable activation results, ACE shows potential clinical application for the weakly-supervised diagnostic suggestions.

### ACE Provides Unsupervised Learning Image Registration Solution

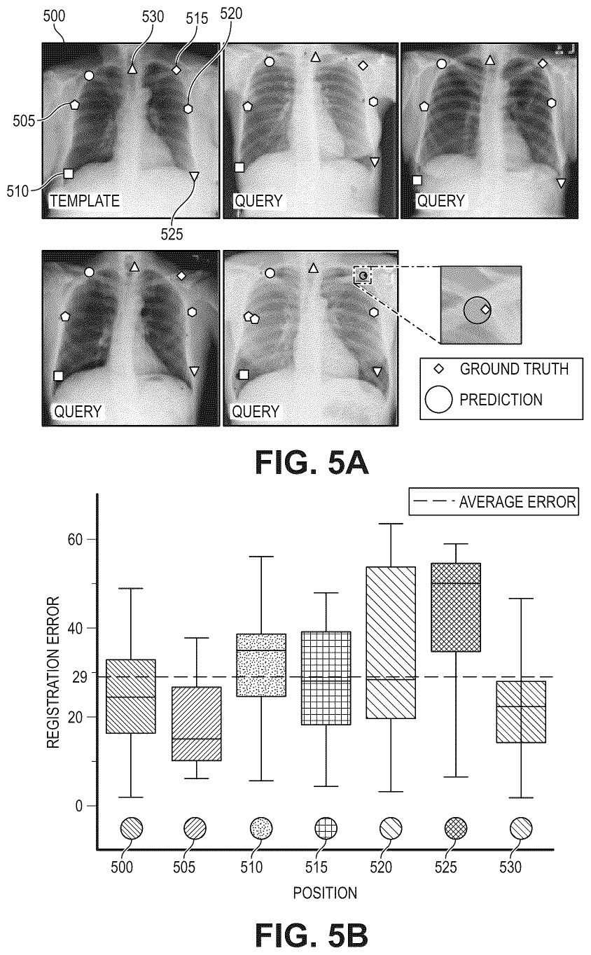

To demonstrate the efficacy of ACE in capturing a diverse range of anatomical structures, patch-level features are utilized to query the same landmark across different patients. The findings related to such indicate that the extracted features reliably represent specific anatomical regions and maintain consistency despite significant morphological variations. Identical landmark regions are consistently identified in FIGS. 5A and 5B (see dots labeled 500, 505, 510, 515, 520, 525, and 530 in the template image in FIG. 5A, and the corresponding (unlabeled) dots in the four query images in FIG. 5A). These figures provide examples of image registration results. Embodiments can effectively localize selected anatomical landmarks across patients using only embeddings. FIG. 5B graphically illustrates average L2 distance between predicted corresponding landmarks 500, 505, 510, 515, 520, 525, and 530 and ground truth at each position. The boxes in FIG. 5B that correspond to the dots in FIG. 5A have an average registration error across the seven landmarks of 29 pixels.

### ACE Provides Robust Local Feature-Driven Global Image Retrieval

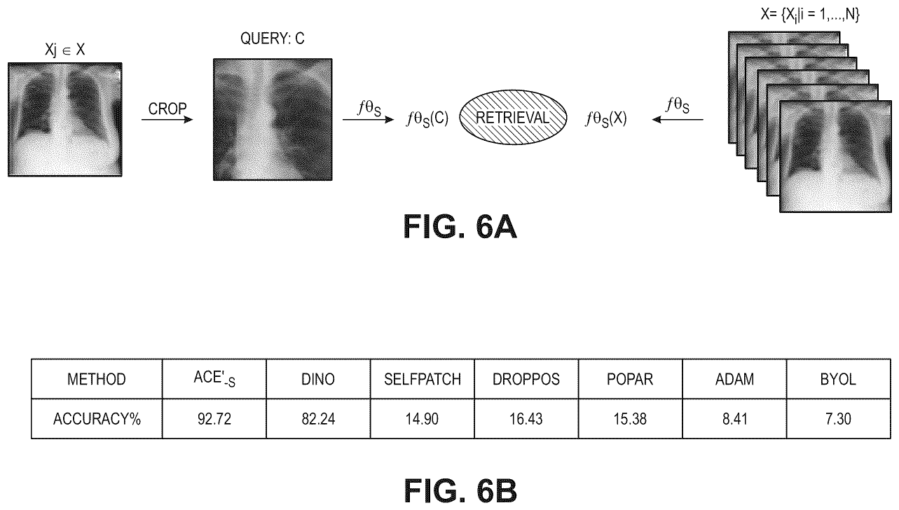

Experimental setup: the test set for ChestX-ray14 dataset was split into batches, each batch X={Xᵢ|i=1, . . . , N}, consisting of N images, where N is 32 in the experiments. FIGS. 6A and 6B depict an enhanced image retrieval process in accordance with embodiments of the invention. The embedding of a cropped portion is used as a query to retrieve the original image within a batch. As demonstrated by FIG. 6A, for each image Xⱼ∈X, a cropping operation is applied to generate a query image C. Subsequently, the feature extraction model ACE's) f_{θs} maps both the query image C and the dataset images X into the embedding space. The retrieval is then executed based on the cosine similarity scores between f_{θs} (C) and f_{θs} (Xᵢ) for all i, selecting the image with the maximal similarity to C.

Results: The approach demonstrates a significant lead in retrieval accuracy with a score of 92.72% for the disclosed embodiments, which bests all the other approaches, as presented in FIG. 6B. Indeed, performance for the disclosed embodiments is notably higher compared to competing methods, which underscores the model's potential applicability in enhancing diagnostic procedures and facilitating medical image management systems.

### ACE Learns Compact and Composable Feature Representations

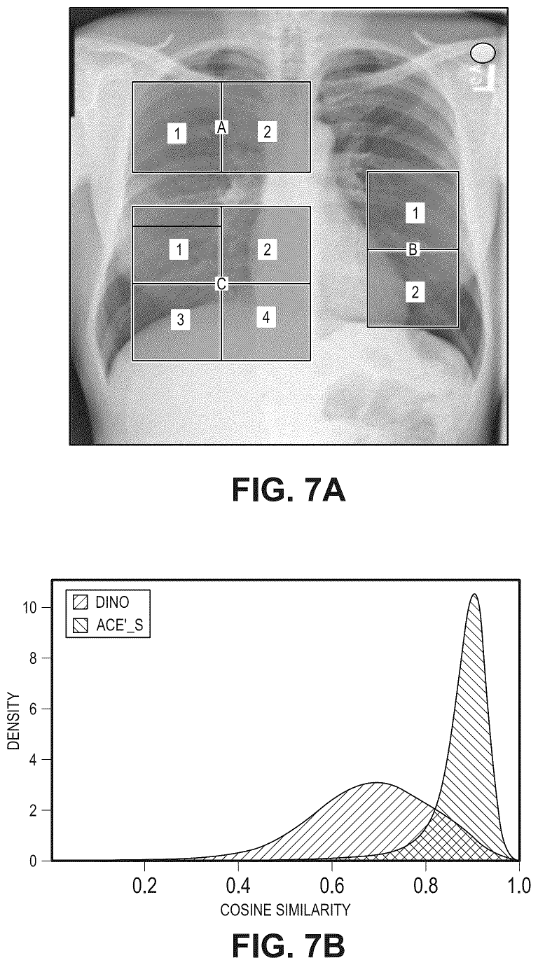

With reference to FIGS. 7A and 7B, embodiments of the invention learn composable embeddings. FIG. 7A depicts randomly cropping a region from an image and decomposing it to 2 or 4 sub-patches A, B and C. FIG. 7B illustrates calculating cosine similarity between the embedding of the region and the average embedding of sub-patches. The values are illustrated with Gaussian kernel density estimation (KDE). The model has the ability to condense complex information into compact, composable embeddings, which is evidenced by the density plots in FIG. 7B, by following the experimental setup. Here, the distribution under the model ACE′₋ₛ is noticeably more peaked and shifted towards higher cosine similarity values, indicating a closer correspondence between the whole image embeddings and their compositional parts, underscoring the model's skillful integration of cohesive features while efficiently maintaining the compositional integrity of anatomical structures.

### ACE Enhances Features Decomposition

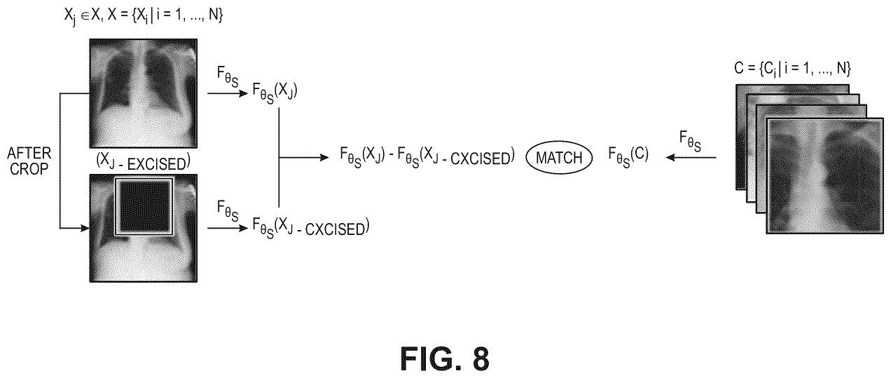

Experimental Setup: Refer to FIG. 8 for the model's decomposition study. Local regions, 30-60% of the original image size, are extracted from various images, labeled as Cⱼ. The model computes embeddings for the entire image Xⱼ, The image with a region removed X_{j-excised}, and the excised region Cⱼ. The hypothesis for decomposition is expressed:

$${f}_{{θ}_{s}} ( {X}_{j} ) - {f}_{{θ}_{s}} ( {X}_{j - excised} ) \approx {f}_{{θ}_{s}} ( {C}_{j} ) \qquad ( 10 )$$

The ChestX-ray14 test set is divided into batches, each containing 32 images. For each image in a batch, a region is randomly occluded. The embedding difference between f_{θs} (Xⱼ) and f_{θs} (X_{j-excised}) is calculated. This difference is compared against embeddings of randomly cropped areas from the same batch using cosine similarity, identifying the most similar crop.

Results: the ACE′₋ₛ model achieves a significant lead in accuracy at 88.83%, surpassing the DINO model which stands at 58.88%. This notable increase in accuracy evidences the ACE's model's superior capability in learning decomposable embeddings, cementing the model's utility for understanding top-down structure of chest radiology.

### ACE Exhibits Superior Interpretability of Medical Pretrained Models

The model exhibits a multitude of superior characteristics within the embedding space, which are instrumental in augmenting the interpretability of medical pretrained models.

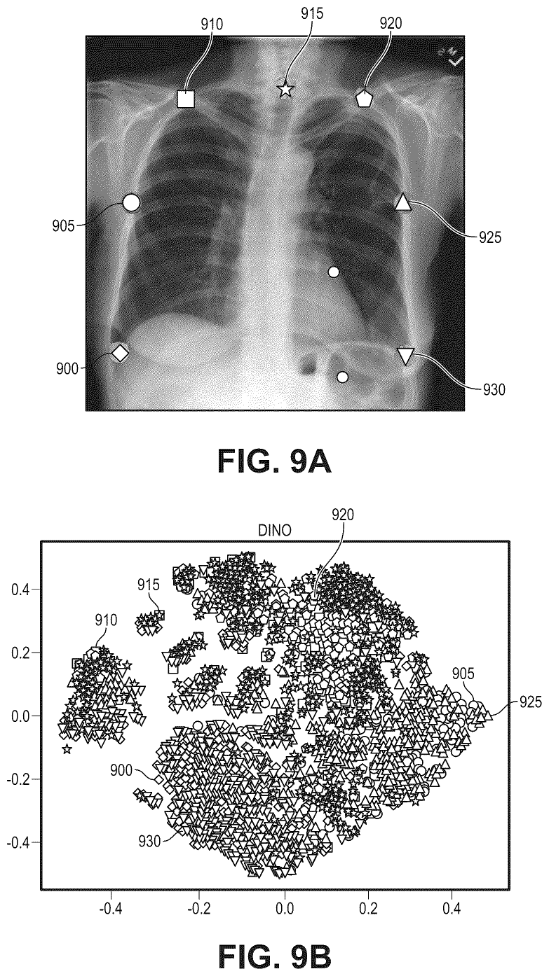

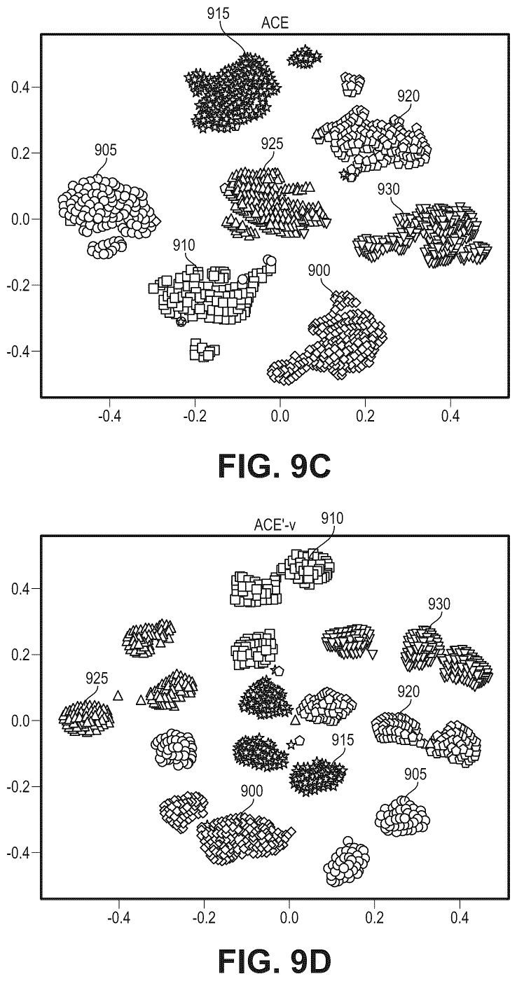

(1) ACE provides distinctive anatomical embedding. In the analysis represented in FIG. 9A, t-SNE is employed to visualize the embeddings of anatomical landmarks (see dots 900, 905, 910, 915, 920, 925 and 930). The dataset comprises images from 1000 patients, with unique anatomical structures indicated by distinctly numbered dots. The advanced model, illustrated in FIG. 9D and denoted as ACE′₋ᵥ, shows superior discriminability in identifying anatomical landmarks compared to the DINO model illustrated in FIG. 9B.

The comparative visuals underscore the enhancements; DINO's model yields overlapping clusters with fuzzy peripheries, whereas ACE′₋ᵥ delineates each cluster with pronounced borders and notable separation. This sharp demarcation is essential for accurate detection of anatomical landmarks in medical imagery, highlighting the refined embedding space of ACE′₋ᵥ for discrete local anatomical features.

Moreover, as shown in FIGS. 9C and 9D, comparing with ACE (FIG. 9C), ACE′₋ᵥ (FIG. 9D) not only clarifies the cluster boundaries but also cultivates a more distinct embedding within the clusters by leveraging an enlarged embedding dimension of global consistency loss. This approach promotes feature diversity, which is pivotal for the robust identification of anatomical landmarks.

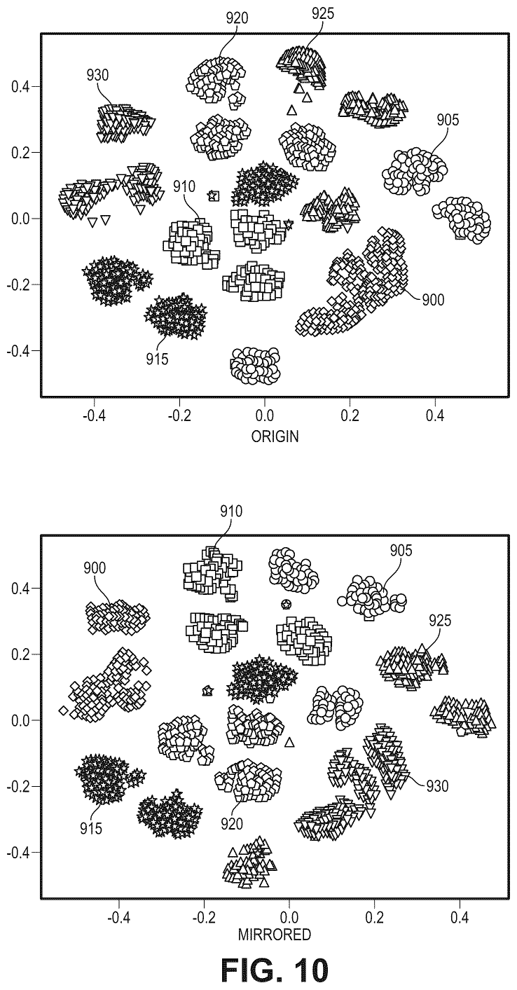

(2) ACE understands anatomical symmetry. To assess the model's proficiency in discerning anatomical symmetry, a t-SNE analysis was conducted (FIG. 10), posing the embeddings of landmarks post-mirroring with those of intrinsically symmetrical anatomical landmarks. In FIG. 10, t-SNE embeddings were analyzed for the seven landmarks 900, 905, 910, 915, 920, 925 and 930 and their mirrored versions from 1000 patients, resulting in 14 embeddings each. Scatter plots show the distributions of original and mirrored landmarks. The overlap of corresponding points, like original dots 910 and mirrored dots 920, confirms the method's effectiveness in capturing anatomical symmetry. The t-SNE visualization indicates a notable similarity in the spatial distribution of mirrored landmarks and their corresponding symmetrical entities within the anatomical context. This alignment suggests that the model effectively captures the symmetrical attributes of anatomical structures, further confirming its ability to comprehend the overarching anatomical configurations essential for accurate landmark detection.

### Ablation Study

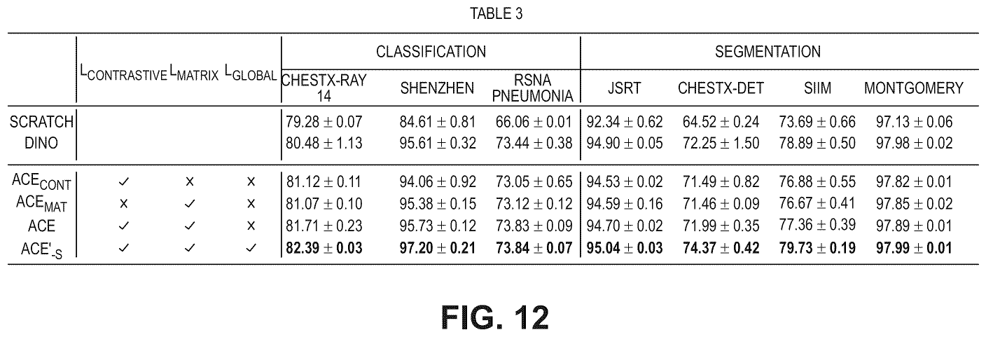

The following discussion refers to ablation studies to understand further how ACE works. To this end, all cases are pretrained based on Swin-B on ChestX-ray14 dataset for 300 epochs with a batch size of eight and the pretrained models are evaluated on seven target classification and segmentation tasks. Table 3, presented in FIG. 12, shows the individual effects of ACE's components: (a) global consistency (“L_{global}” column), (b) contrastive learning (“L_{contrastive}” column) and (c) corresponding matrix matching (“Lₘₐₜᵣᵢₓ” column). Every ablation is compared to the performances of training from scratch and the baseline DINO. From the results in Table 3 several observations and conclusions are obtained: (1) all ablative versions surpass the model training from scratch which evaluate the effectiveness for each component; (2) ACE_{cont} and ACEₘₐₜ get comparable performances for the seven target tasks and the additive version ACE is more prominent which proves the combination of two components is better than each one; (3) a full version ACE's outperforms DINO, suggesting the superiority of local consistency loss based on equally using global loss.

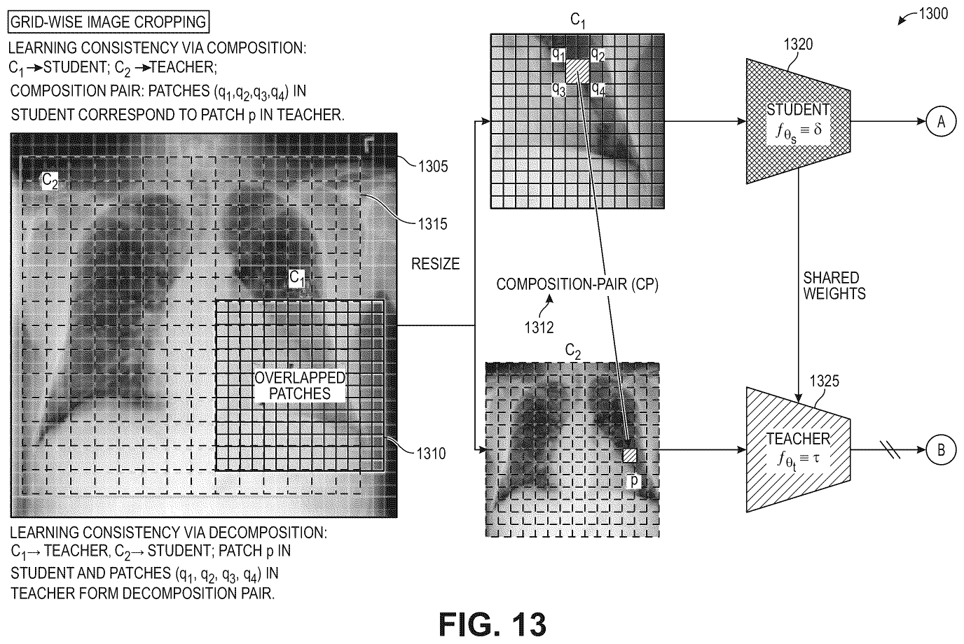

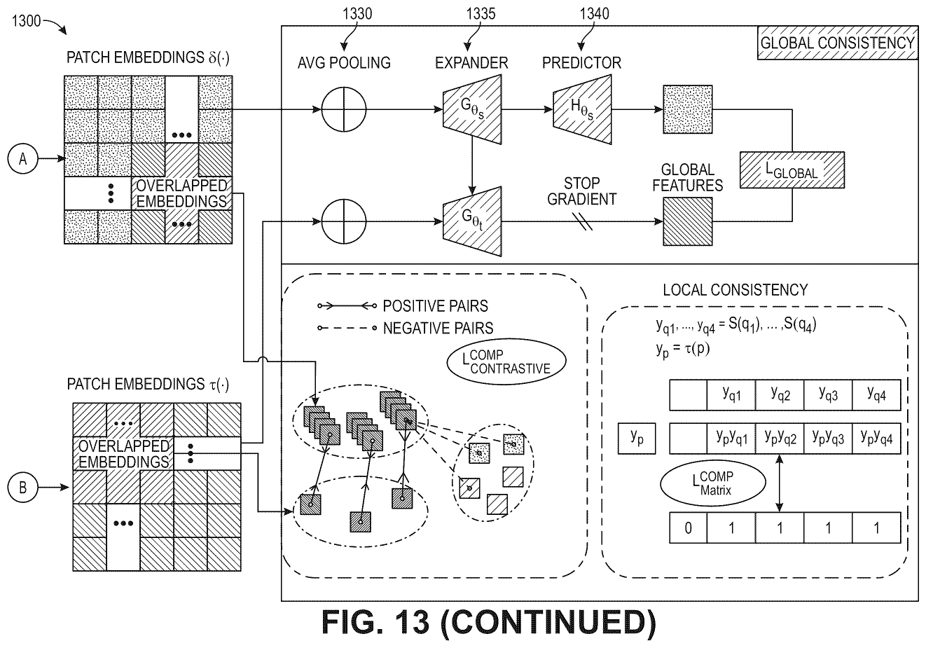

FIG. 13 illustrates an ACE framework, according to a second disclosed embodiment, in which simultaneously learning from global and local consistencies via composition and decomposition can equip a machine learning model to understand the anatomy, thereby offering strong transferability. The framework illustrated in FIG. 13 enables the capture of anatomical structures from unlabeled data, resulting in a powerful pre-trained machine learning model, via an innovative composition and decomposition strategy. The framework according to this embodiment comprises two novel components: learning global consistency and local consistency via composition and decomposition, as discussed further below in section two. ACE according to this embodiment utilizes novel grid-wise image cropping, which differs from the existing random cropping strategy, to provide truly precise patch matching. Based on this cropping strategy, two randomly cropped views to the student-teacher model in the global consistency branch are guaranteed to have overlaps, reducing the feature irrelevances. In the local consistency branch, the student-teacher model is used to mimic the human understanding of part-whole relationships in images, where the embedding of a “whole” patch in one branch should always be consistent with the aggregated embedding of all “part” patches from the other branch, a process that is referred to as composition and decomposition. This process is based on precise patch matching, which differs significantly from the existing approximate matching methods because they compute local consistency by narrowing the distance of semantically closest or spatially nearest features. ACE, according to the disclosed embodiment, simultaneously optimizes a loss that integrates global and local consistencies to learn anatomically consistent embedding.

The embodiment illustrated in FIG. 13 may be used to focus on chest X-rays (CXRs) because the chest contains several critical organs prone to diseases associated with significant healthcare costs. Comprehensive experiments on CXRs yield three main contributions:

(1) a new idea for learning compositionality and decompositionality from unlabeled medical images, demonstrating that deep models can comprehend anatomical structures in human's way;
(2) a novel capacity for feature-drive image retrieval and cross-patient anatomy correspondence without downstream training, opening up new potential for applying SSL in medical imaging; and
(3) a new SSL method with prominent transferability to various target tasks in medical image analysis.

Medical images acquired from standardized protocols show consistent macroscopic/microscopic anatomical structures. These structures consist of composable/decomposable organs and tissues, but existing self-supervised learning (SSL) methods, mainly designed for photographic images, do not appreciate such composable/decomposable structure attributes inherent to medical images. To overcome this limitation, the disclosed embodiments introduce a novel SSL approach called ACE to learn anatomically consistent embedding via composition and decomposition with two key branches: (1) global consistency, capturing discriminative macro-structures via extracting global features; (2) local consistency, learning fine-grained anatomical details from composable/decomposable patch features via contrastive learning and corresponding matrix matching. Experimental results across six datasets and two backbones, evaluated in linear probing, few-shot learning, fine-tuning, and property analysis, show ACE's superior robustness, transferability, and clinical potential. The innovations of ACE, according to the disclosed embodiment, lie in grid-wise image cropping, leveraging the intrinsic properties of compositionality and decompositionality of medical images, bridging the semantic gap from high-level pathologies to low-level tissue anomalies, and providing a new SSL method for medical imaging.

According to the following disclosed embodiment 1300, ACE learns anatomical embedding with global consistency and local consistency via composition and decomposition as illustrated in FIG. 13. From a gridded training image 1305, according to the novel cropping strategy detailed hereinbelow, two crops C₁ 1310 and C₂ 1315 are extracted in respective grids, resulting in composition-pairs (CPS) 1312. For example, patches q₁, q₂, q₃, and q₄ in C₁ “compose” patch p in C₂, forming a CP. ACE learns local consistency via composition by inputting C₁ to the Student part 1320 of the model and C₂ to the Teacher part 1325 of the model and optimizing two losses: (1) contrastive loss using all CPs as positive pairs and non-overlapped patches as negative pairs; (2) matching loss using a corresponding matrix, whose entries are 1s between a patch in C₂ and all its overlapped patches in C₁ and 0s for all non-overlapped patches between C₁ and C₂. The contrastive and matching losses are complementary in learning local consistency from two different perspectives. Symmetrically, by inputting C₂ 1315 to Student 1320 and C₁ 1310 to Teacher 1325, ACE learns local consistency via decomposition. To learn global consistency, ACE maximizes the global embeddings' consistency of C₁ and C₂. By simultaneously optimizing a loss that integrates global and local consistencies, ACE learns anatomically consistent embedding as demonstrated by those learned and emergent properties as further discussed below.

(1) Grid-wise image cropping. The disclosed embodiments achieve precise patch matching for ACE to learn global and local consistency in anatomy. Embodiments first grid at 1305 a training image into (32×m)², where m is the height/width of each grid, and then randomly crop two views C₁ and C₂ according to the grid. C₂ has a size of [14×(k×m)]×[14×(l×m)] with k, l∈{1, 2}, while C₁ has a fixed size of (14×m)², starting at one of C₂'s nodes for exact alignment in grids. As an example, when k, l=2, the sizes of C₁ and C₂ are (14×m)² and (28×m)², respectively. In the area where C₁ and C₂ overlap, a patch in C₂ corresponds to four patches in C₁, forming a composition-pair (CP) 1312.

(2) Learning global consistency. The two crops are resized to the same shape C₁,C₂∈R^{C×H0×W0}, where C,H₀,W₀ are channel, height, width, and input into Student and Teacher f_{θs}, f_{θt} parts 1320 and 1325 to get patch embeddings yₛ, yₜ=f_{θs} (C₁), f_{θt} (C₂)∈R^{D×H×W} respectively, followed by average pooling ⊕ at 1330 to get global embeddings y_{s⊕}, y_{t⊕}∈R^{D}, and expanders g_{θs}, g_{θt} 1335 for expanding dimensions to yield y′_{s⊕}, y′_{t⊕}∈R^{H}. Finally, a predictor h_{θs} 1340 is inserted in the Student part to predict the embedding of the Teacher part: y″_{s⊕}=h_{θs} (y′_{s⊕})∈R^{H}. Cross-entropy loss is minimized to constrain the global consistency:

$${ℒ}_{global} = CE ( {y}_{s ⊕}^{″} , {y}_{t ⊕}^{′} ) \qquad ( 1 )$$

(3) Learning local consistency in composition and decomposition. Learning local consistency by contrastive learning. Intuitively, the embedding of a whole should be equal to or close to the average of the embeddings of its each part. Consequently, a composition is defined in learning local features: f_{θt} (p)≈¼ (fθs(q₁)+f_{θs}(q₂)+f_{θs}(q₃)+f_{θs}(q₄)), where p, corresponding to four overlapped patches q₁, q₂, q₃, q₄ is a composition pair shown in FIG. 13. For patch embedding sets of C₁, C₂ in student and teacher branch K^{(s)}={yₜᵢ}∈R^{D}, 1≤i≤HW, the overlapped patch embedding set O^{(s)}={yₛᵢ}, 1≤i≤m and O^{(t)}={yₜᵢ}, 1≤i≤n are subsets of K^{(s)}, K^{(t)}, where m and n are the numbers of overlapped patches for C₁, C₂ and m=4n in the case of FIG. 13. The rest non-overlapped patch embeddings are N^{(s)}=K^{(s)}−O^{(s)} and N^{(t)}=K^{(t)}−O^{(t)}. The composition pairs in C₁ and C₂ are regarded as positive pairs and the rest non-overlapped patches are negatives. To learn compositionality, the four overlapped patch embeddings in the student branch are averaged, composing to one overlapped patch in teacher branch whose gradient is stopped and can be regarded as ground truth. Accordingly, the averaged overlapped patch embeddings set in student branch is O^{(s)}={y_{slθ}}, 1≤i≤n, where y_{slθ} is the average embedding of every four overlapped embeddings, whose elements should be one-to-one corresponding with elements in O^{(t)}. InfoNCE is designed for contrastive learning loss to learn patch level local consistency via composition:

$${ℒ}_{contrastive}^{comp} = - log \frac{{e}^{( q \cdot {k}_{+} / τ )}}{{\sum }_{i = 1}^{N} {e}^{( q \cdot {k}_{i} / τ )}} \qquad ( 2 )$$

where q∈O^{(s)}, k₊ is the corresponding positive embedding in O^{(t)} and N is the overall number of patch embeddings in a mini-batch which contains overlapped and non-overlapped patch embeddings. To learn decompositionality, C₂, C₁ are symmetrically input to student and teacher branches. In this case, a patch embedding from student branch can be decomposed into four embeddings from teacher branch and the loss is the same with Eq. 2:

$${ℒ}_{contrastive}^{comp} = {ℒ}_{contrastive}^{decomp} and {ℒ}_{contrastive} = ( {ℒ}_{contrastive}^{comp} + {ℒ}_{contrastive}^{decomp} ) / 2.$$

Learning local consistency by corresponding matrix matching. To strengthen the local consistency, the correlation matrix of the patch embeddings is computed and optimized from the two crops. In detail, when learning consistency via composition, C₁ is input to student and C₂ to teacher model. K=H×W embeddings are obtained from each branch: y\hat{ }ₛ, y\hat{ }ₜ∈R^{D×K} and calculate cross-correlation matrix P=sigmoid (y\hat{ }Tₛ·y\hat{ }ₜ)∈R^{K×K}, Tis matrix transpose, (·) is matrix multiplication. The target matrix [symbol] ∈R^{K×K} whose value in the position (i, j):

$${Q}^{( i , j )} = \{ \begin{matrix}1 , & if {C}_{1}^{i} , {C}_{2}^{j} are composition - pairs \\ 0 , & else\end{matrix} \qquad ( 3 )$$

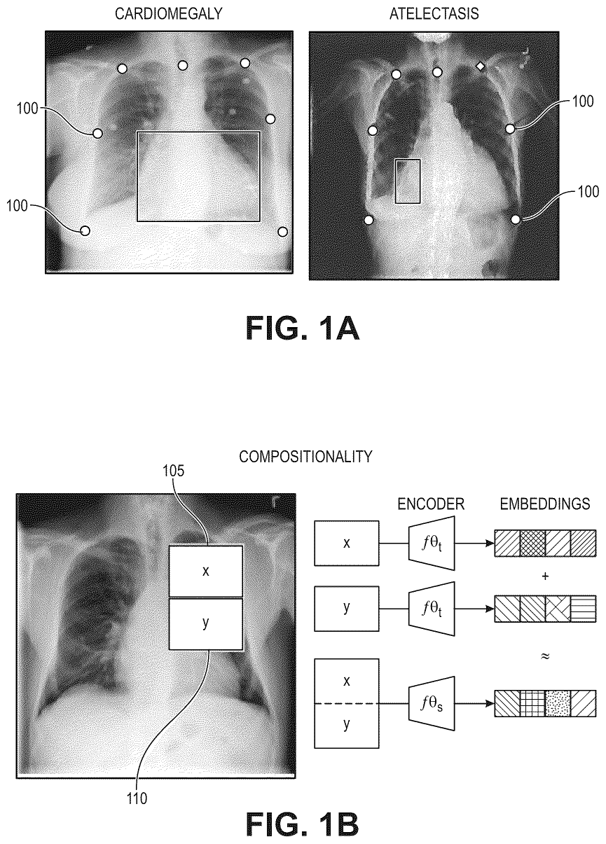

The weighted cross-entropy (CE) loss is used to get close to the embedding correlation matrix P and index correlation matrix [symbol] :

$${ℒ}_{matrix}^{comp} = ( α \cdot Q + ( 1 - α ) \cdot ( 1 - Q ) ) \cdot CE ( P , Q ) \qquad ( 4 )$$

where α is used to balance the positive and negative samples. In FIG. 1, four patches in C₁ correspond to one patch in C₂ which results in four positive samples in that row.

To learn decomposition, C₂ and C₁ are inversely input to student and teacher branches to learning and the target matrix will be transposed as [symbol] ^{T}. The decomposition loss is:

$${ℒ}_{matrix}^{decomp} = ( α \cdot {Q}^{T} + ( 1 - α ) \cdot ( 1 - {Q}^{T} ) ) \cdot CE ( P , {Q}^{T} ) \qquad ( 5 )$$

The corresponding matrix loss is

$${ℒ}_{matrix} = ( {ℒ}_{matrix}^{comp} + {ℒ}_{matrix}^{decomp} ) / 2.$$

Finally, the total loss is defined in equation 6, where L_{global} is the global consistency loss, L_{contrastive} and Lₘₐₜᵣᵢₓ are two terms of local consistency loss. The L_{global} empowers the model to learn coarse-grained anatomical structure from global patch embeddings. L_{contrastive} and Lₘₐₜᵣᵢₓ equip the model to learn precisely fine-grained local anatomical structures in composition and decomposition.

$$ℒ = {ℒ}_{global} + {ℒ}_{contrastive} + {ℒ}_{matrix} \qquad ( 6 )$$

Thus, according to this embodiment, a method can be performed by a system having at least a processor and a memory therein to execute instructions to enable a machine learning model to learn anatomical embeddings with global consistency and local consistency from unlabeled data. The method comprises receiving a plurality of unlabeled medical images comprising macroscopic and microscopic anatomical structures that consist of composable/decomposable organs and tissues, grid-wise image cropping the plurality of medical images to yield two randomly cropped views that have overlaps, thereby reducing the feature irrelevances, transmitting the two randomly cropped views to a global consistency branch in a student-teacher model, and mimicking a human understanding of part-whole relationships in the medical images in a local consistency branch of the student-teacher model, where embedding of a whole patch in one branch is consistent with aggregated embedding of all part patches from the other branch.

According to this embodiment, mimicking human understanding of part-whole relationships in the medical images comprises simultaneously learning consistent embedding via composition and decomposition with a global consistency branch in a student-teacher model that captures discriminative macro-structures via extracting global features, and a local consistency branch in the student-teacher model that learns fine-grained anatomical details from composable/decomposable patch features via contrastive learning and corresponding matrix matching.

Further, according to this embodiment, grid-wise image cropping comprises extracting two overlapping crops from one of the medical images, resulting in a composition pair, CP, comprising a first crop and a second crop, wherein a plurality of patches in the first crop compose a patch in the second crop, wherein transmitting the two randomly cropped views to a global consistency branch in a student-teacher model comprises transmitting the first crop to a student portion of a student-teacher network of the machine learning model, and transmitting the second crop to the teacher portion of the student-teacher network of the machine learning model.

The mimicking of human understanding of part-whole relationships in the medical images in a local consistency branch of the student-teacher model comprises learning a local consistency via composition by optimizing a contrastive loss using all CPs as positive pairs and non-overlapped patches as negative pairs and matching loss using a corresponding matrix whose entries are 1s between a patch in the second crop and all its overlapped patches in the first crop and 0s for all non-overlapped patches between the first crop and the second crop.

This disclosed embodiment further comprises transmitting the second crop to a student portion of a student-teacher network of the machine learning model, transmitting the first crop to the teacher portion of the student-teacher network of the machine learning model, learning a local consistency via decomposition, learning a global consistency by maximizing a global embeddings' consistency of the first crop and the second crop, and simultaneously optimizing a loss that integrates the global consistency and the local consistency to learn an anatomically consistent embedding.

### Experiments and Results

(1) Settings for pretraining and evaluations. Embodiments pretrain ACE from scratch on unlabeled ChestX-ray14 dataset with Swin-B (ACEs) and ViT-B (ACEv) backbones. For a fair comparison, the same experimental setting and dataset is used to pretrain DINO, BYOL, SelfPatch, Adam, POPAR and DropPos. The pretrained models are evaluated by showing their learned and emergent properties, linear-probing, few-shot learning, and finetuning protocols.

### (2) Properties of Pretrained ACE Model

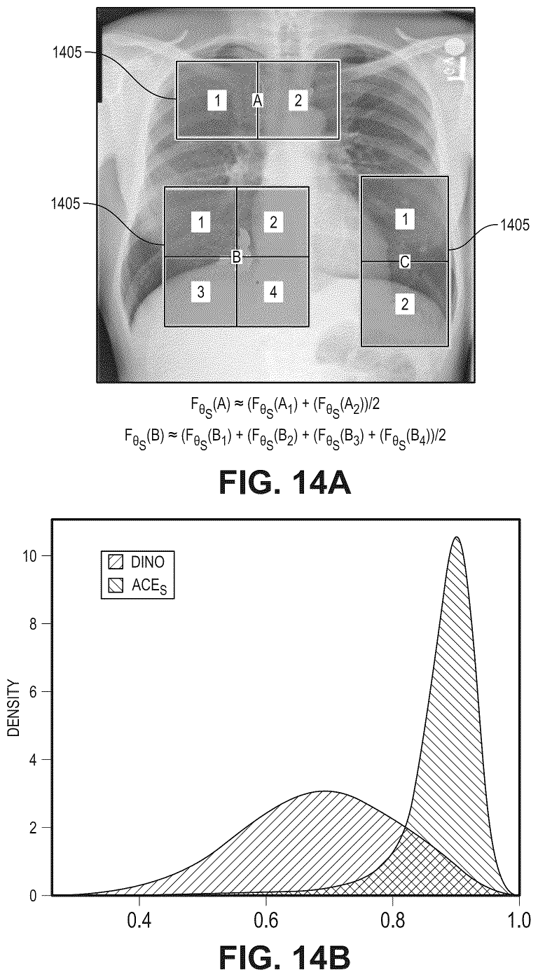

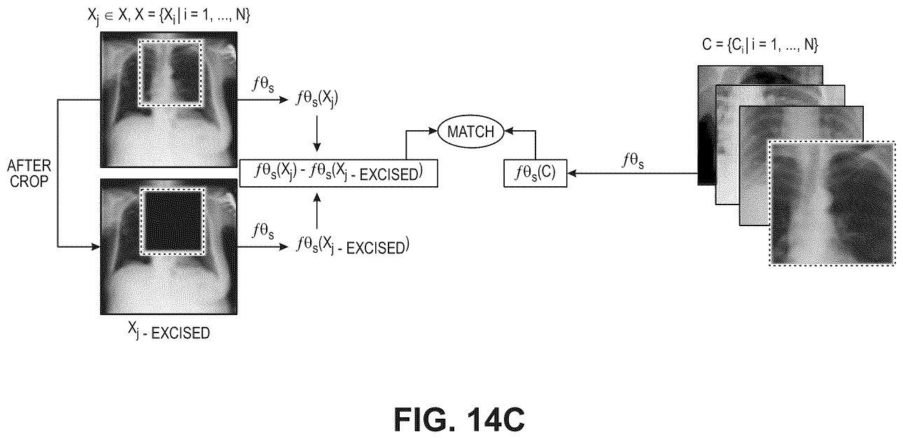

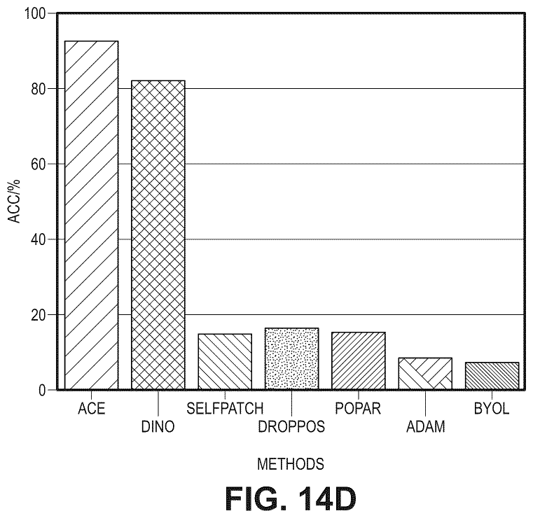

FIGS. 14A and 14B depict ACE learned properties of feature compositionality, while FIG. 14C depicts decompositionality and FIG. 14D depicts image retrieval.

Learned property 1: ACE enhances feature compositionality. To explore ACE's ability to comprehend compositionality of anatomical structures, embodiments follow and set the experiment: randomly crop a region from an image and decompose it to two or four sub-patches 1405 shown in FIG. 14A, then calculate cosine similarity between the embedding of the region and the average embedding of sub-patches and report the values with Gaussian kernel density estimation (KDE) shown in FIG. 14B. The distribution under the model ACEs is noticeably more peaked and shifted towards higher cosine similarity values, indicating a closer correspondence between the whole image embeddings and their compositional parts, underscoring the model's skillful integration of cohesive features while efficiently maintaining the compositional integrity of anatomical structures.

Learned property 2: ACE enhances feature decompositionality. Refer to FIG. 14C for the model's decompositionality study. Local regions, 30-60% of the original image size, are extracted from various images, labeled as Cⱼ. The model computes embeddings for the entire image Xⱼ, the image with a region removed X_{j-excised}, and the excised region Cⱼ. The hypothesis for decomposition: f_{θs} (Xⱼ)−f_{θs} (X_{j-excised})≈f_{θs} (Cⱼ). The ChestX-ray14 test set is divided into batches, each containing 32 images. Cosine similarity is calculated between f_{θs} (Xⱼ)−f_{θs} (X_{j-excised}) and f_{θs} (Cⱼ), finding out if the most similar value match Cⱼ correctly. The ACE model achieves accuracy at 88.83%, surpassing the DINO model at 58.88%. This notable increase in accuracy evidences the ACEs model's superior capability in learning decomposable embeddings.

Learned property 3: ACE provides robust local feature-driven global image retrieval. Consistent with decompositionality's image cropping setting, an image crop C is taken as the query image, and a retrieval process is executed based on the cosine similarity scores between f_{θs} (C) and f_{θs} (Xᵢ) where Xᵢ is the whole image in a batch, selecting the image with the maximal similarity to C. The novel approach achieves a significant lead in retrieval accuracy with a score of 92.72% shown in FIG. 14D. This performance is notably higher than competing methods, underscoring the model's potential applicability in enhancing diagnostic procedures and facilitating medical image management systems.

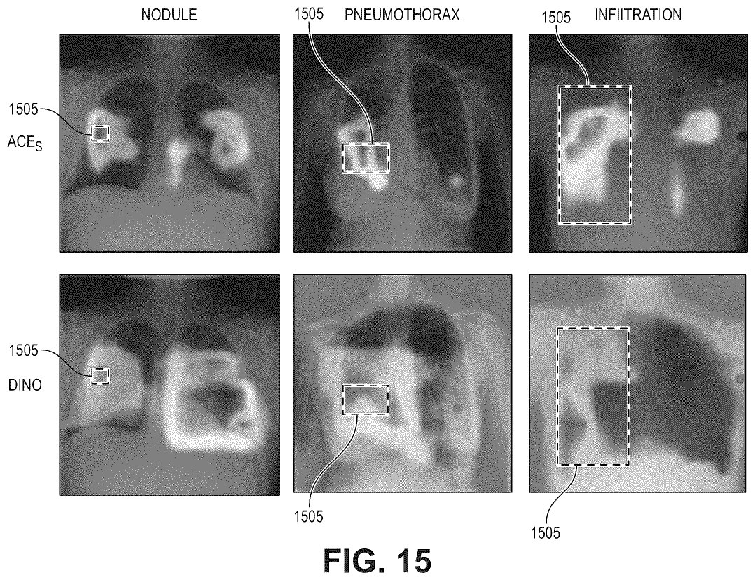

FIG. 15 depicts ACE providing more precise weakly-supervised disease localization. FIG. 9 (introduced above in connection with the discussion of the first embodiment) depicts discriminative anatomical embeddings, and FIG. 5A (introduced above in connection with the discussion of the first embodiment) depicts cross-patient correspondence, indicating that ACE has learned compact and localizable anatomical structures.

Learned property 4: ACE improves weakly-supervised disease localization. The method is tested in a weakly-supervised learning setting: after finetuning the ChestX-ray14 with image-level classification labels, Grad-CAM is followed to generate the heatmaps on the test set, which reflect the model discrimination regions, compared with bounding box annotations 1505 shown in FIG. 15. From the results, initializing with the pretrained method, the finetuning model can localize disease more accurately. The interpretable activation results show potential clinical application for the weakly-supervised diagnostic suggestions.

Emergent property 1: ACE provides distinctive anatomical embeddings. Embodiments employ t-SNE to visualize the embeddings of anatomical landmarks. The dataset is the labeled seven anatomical structures on ChestX-ray14 test set visualized in FIG. 9. From the results, ACE shows superior discriminability in identifying anatomical landmarks compared to the DINO model. This sharp distinction is essential for accurately detecting anatomical landmarks in medical imagery, highlighting the refined embedding space of ACE for discrete local anatomical features. This first property and the next property discussed below are considered “emergent” as ACE is never trained with global and local consistencies across patients but such inter-image consistency has automatically emerged from training on intra-image consistency.

Emergent property 2: ACE provides unsupervised cross-patient anatomy correspondence. To demonstrate the efficacy of ACE in capturing a diverse range of anatomical structures, patch-level features are used to query the same landmark across different patients. In FIG. 5A, findings indicate that the extracted features reliably represent specific anatomical regions and maintain consistency despite significant morphological variations.

### (3) Downstream Transferability of ACE

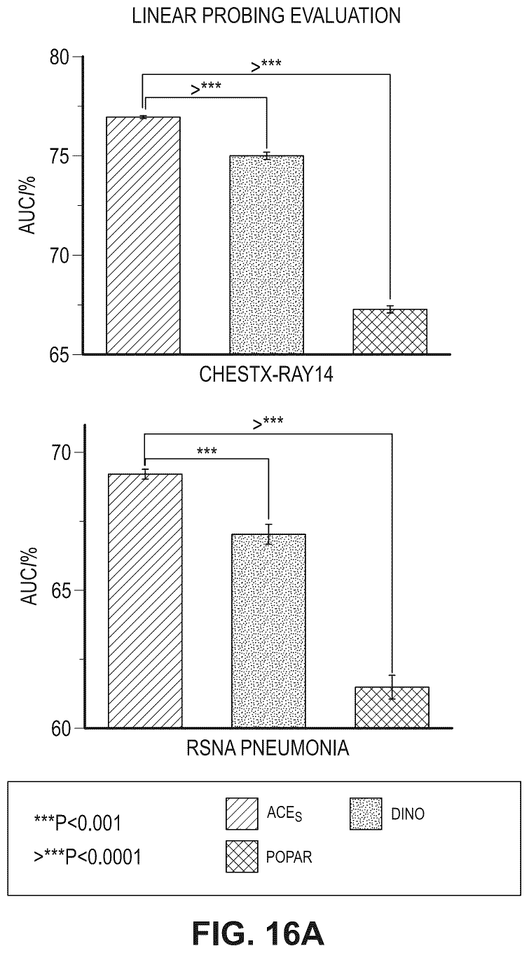

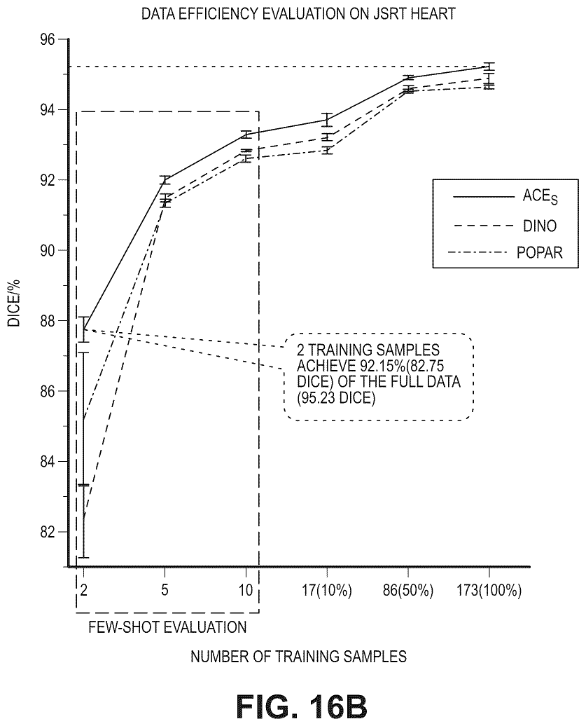

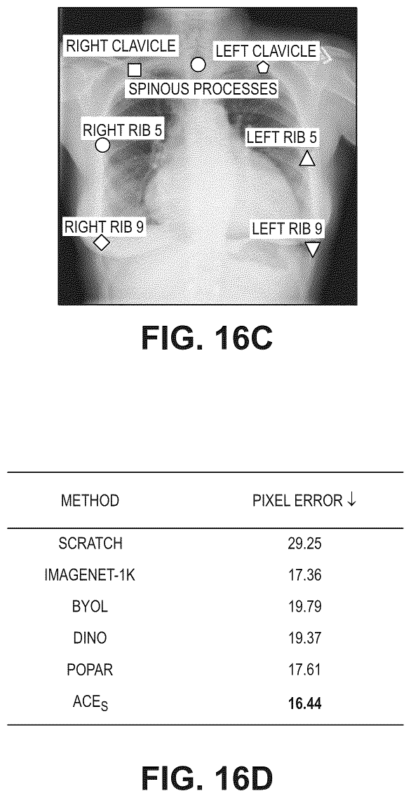

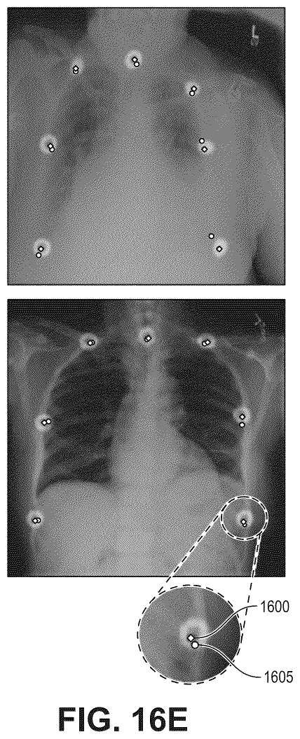

FIG. 16A depicts ACE providing superior performance on linear probing, FIG. 16B depicts data efficiency, and FIGS. 16C, 16D and 16E depict key point detection evaluation. FIG. 16E exhibits the precise detecting results for seven landmarks (diamond 1600: heatmap prediction center; dot 1605: ground truth). As to linear probing evaluation: ACE is evaluated via linear probing on ChestX-ray14 and RSNA Pneumonia datasets shown in FIG. 16A. When the image encoders are fixed and only update the last linear layer, ACE outperforms DINO and POPAR in a great margin from t-test between ACEs and others.

Data efficiency evaluation: to investigate the robustness of representations learned by ACEs, JSRT heart dataset is fine-tuned on different data fractions shown in FIG. 16B. From the results, ACE demonstrates increased gains with the reduction of training samples and when finetuning only on two samples ACE achieves 92.15% performance of the full data.

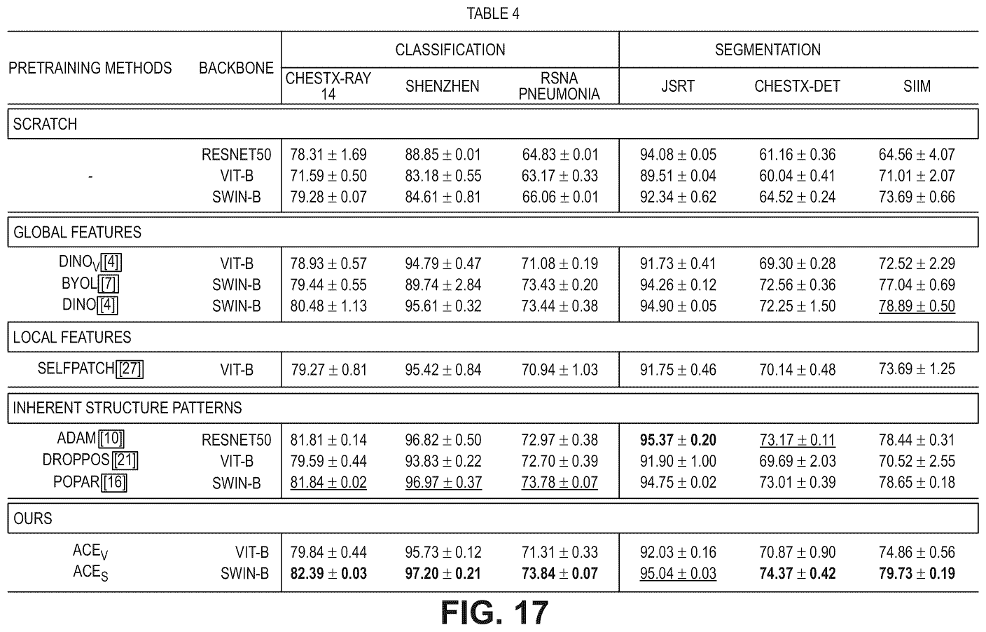

Finetuning evaluation: pretrained ACE is finetuned to classification, segmentation and key point detection tasks with the chosen key points shown in FIG. 16C. With reference to FIG. 16D, the performances are compared with models training from scratch and other self-supervised pretraining methods shown in Table 4 presented in FIG. 17. From the results, several observations can be made: (i) the method surpasses the model training from scratch by a significant margin; (ii) for the Swin-B backbone comparing with BYOL, DINO and POPAR, ACEs achieves the best performances among the six target classification, segmentation and the key point detection dataset; (iii) for the ViT-B backbone, the performances of ACE are outperforming or comparable among the ViT-B methods DINOv, SelfPatch and DropPos; (iv) FIGS. 16D and 16E show accurate key point detection performance.

Analysis: The results shown in linear probing, data efficiency and finetuning evaluations demonstrate the disclosed embodiment's superiority in providing transferable, discriminative, and robust representations.

### Conclusion

Embodiments of the invention (ACE) introduce a novel self-supervised learning method aimed at improving the composition and decomposition of visual representation learning for anatomical structures in medical images. The method according to embodiments relies on unique and reliable local contrastive learning and correspondence matrix matching. ACE has been rigorously tested through comprehensive experiments, demonstrating its effectiveness in transferability. It excels in accurately understanding the structure of common regions, as well as the hierarchical and symmetrical relationships between parts and the whole, showing significant promise for advancing and explainable AI applications in medical image analysis.

Embodiments of the invention contemplate a machine or system within which embodiments may operate, be installed, integrated, or configured. In accordance with one embodiment, the system includes at least a processor and a memory therein to execute instructions including implementing any application code to perform any one or more of the methodologies discussed herein. Such a system may communicatively interface with and cooperatively execute with the benefit of remote systems, such as a user device sending instructions and data, a user device to receive output from the system.

A bus interfaces various components of the system amongst each other, with any other peripheral(s) of the system, and with external components such as external network elements, other machines, client devices, cloud computing services, etc. Communications may further include communicating with external devices via a network interface over a LAN, WAN, or the public Internet.

In alternative embodiments, the system may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, the term “machine” shall also be taken to include any collection of machines (e.g., computers) that individually or jointly execute a set (or multiple sets) of instructions to perform any one or more of the methodologies discussed herein.

An exemplary computer system includes a processor, a main memory (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory (e.g., a persistent storage device including hard disk drives and a persistent database and/or a multi-tenant database implementation), which communicate with each other via a bus. Main memory includes code that implements the three branches of the SSL framework described herein, namely, the localization branch, the composition branch, and the decomposition branch.

The processor represents one or more specialized and specifically configured processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor may also be one or more special-purpose processing devices such as an application-specific integrated circuit (ASIC), a field programmable gate array (FPGA), a digital signal processor (DSP), network processor, or the like. The processor is configured to execute processing logic for performing the operations and functionality discussed herein.

The system may further include a network interface card. The system also may include a user interface (such as a video display unit, a liquid crystal display, etc.), an alphanumeric input device (e.g., a keyboard), a cursor control device (e.g., a mouse), and a signal generation device (e.g., an integrated speaker). According to an embodiment of the system, the user interface communicably interfaces with a user client device remote from the system and communicatively interfaces with the system via a public Internet.

The system may further include peripheral devices (e.g., wireless or wired communication devices, memory devices, storage devices, audio processing devices, video processing devices, etc.).

A secondary memory may include a non-transitory machine-readable storage medium or a non-transitory computer readable storage medium or a non-transitory machine-accessible storage medium on which is stored one or more sets of instructions (e.g., software) embodying any one or more of the methodologies or functions described herein. The software may also reside, completely or at least partially, within the main memory and/or within the processor during execution thereof by the system, the main memory and the processor also constituting machine-readable storage media. The software may further be transmitted or received over a network via the network interface card.

In addition to various hardware components depicted in the figures and described herein, embodiments further include various operations which are described herein. The operations described in accordance with such embodiments may be performed by hardware components or may be embodied in machine-executable instructions, which may be used to cause a specialized and special-purpose processor having been programmed with the instructions to perform the operations described herein. Alternatively, the operations may be performed by a combination of hardware and software. In such a way, the embodiments of the invention provide a technical solution to a technical problem.

Embodiments also relate to an apparatus for performing the operations disclosed herein. This apparatus may be specially constructed for the required purposes, or it may be a special purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

While the algorithms and displays presented herein are not inherently related to any particular computer or other apparatus, they are specially configured and implemented via customized and specialized computing hardware which is specifically adapted to more effectively execute the novel algorithms and displays which are described in greater detail herein. Various customizable and special purpose systems may be utilized in conjunction with specially configured programs in accordance with the teachings herein, or it may prove convenient, in certain instances, to construct a more specialized apparatus to perform the required method steps. The required structure for a variety of these systems will appear as set forth in the description. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method performed by a system having at least a processor and a memory therein to execute instructions for a self-supervised learning framework to learn anatomically consistent embeddings of anatomical structures in medical images of a plurality of patients across varying scales of anatomical structures in the plurality of patients,
receiving a medical image as an input;
obtaining a first cropped image and a second overlapping cropped image of the received medical image, each having respective representative global embeddings and corresponding overlapped patch embeddings and non-overlsapped patch embeddings;
calculating a global consistency loss using the respective representative global embeddings; and
calculating a local consistency loss using the corresponding overlapped patch embeddings and non-overlapped patch embeddings.

2. The method of claim 1, wherein calculating the local consistency loss using the corresponding overlapped patch embeddings and non-overlapped patch embeddings, comprises calculating a contrastive learning loss and a corresponding matrix matching loss.

3. The method of claim 2, wherein calculating the contrastive learning loss comprises receiving the first and second cropped images at respective student and teacher networks of the self-supervised learning framework, wherein the first cropped image comprises four overlapped patch embeddings that correspond to the patch embedding in the second cropped image, to yield a compositionality-pair of patches that are positive and non-overlapped patches that are negative.

4. The method of claim 3, wherein calculating the corresponding matrix matching loss comprises receiving the first and second cropped images at respective teacher and student networks of the self-supervised learning framework to learn decompositionality for local consistency.

5. The method of claim 4, wherein obtaining the first cropped image and the second overlapping cropped image of the received medical image, each having respective representative global embeddings and corresponding overlapped patch embeddings and non-overlapped patch embeddings, comprises:
organizing the medical image into a two-dimensional grid of image elements (“patches”);
randomly selecting a first plurality of the patches in the two-dimensional grid to obtain the first cropped image;
selecting a second plurality of patches in the two-dimensional grid that overlap, and are a multiple of, the first plurality of patches to obtain the second cropped image; and
resizing the first cropped image and the second cropped image to a same shape.

6. The method of claim 5, wherein obtaining the first cropped image and the second overlapping cropped image of the received medical image, each having respective representative global embeddings and corresponding overlapped patch embeddings and non-overlapped patch embeddings, further comprises:
receiving the resized first and second cropped images at respective student and teacher networks of the self-supervised learning framework and generating respective patch embeddings therefrom; and
receiving the respective patch embeddings at respective average pooling operators and generating the respective representative global embeddings therefrom.

7. The method of claim 6, wherein obtaining the first cropped image and the second overlapping cropped image of the received medical image, each having respective representative global embeddings and corresponding overlapped patch embeddings and non-overlapped patch embeddings, further comprises: receiving the respective representative global embeddings at respective student and teacher expanders to expand dimensions of the respective representative global embeddings.

8. The method of claim 7, wherein obtaining the first cropped image and the second overlapping cropped image of the received medical image, each having respective representative global embeddings and corresponding overlapped patch embeddings and non-overlapped patch embeddings, further comprises receiving the expanded representative global embedding from the student expander at a predictor in the student network to the representative global embedding of the teacher network.

9. A system comprising:
a memory to store instructions;
a processor to execute the instructions stored in the memory;
a receive interface to receive a plurality of medical images obtained from a plurality of patients;
wherein the system is configured to perform self-supervised learning to learn anatomically consistent embeddings of anatomical structures in medical images of a plurality of patients across varying scales of anatomical structures in the plurality of patients, by executing the instructions via the processor for:
obtaining a first cropped image and a second overlapping cropped image of the received medical image, each having respective representative global embeddings and corresponding overlapped patch embeddings and non-overlapped patch embeddings;
calculating a global consistency loss using the respective representative global embeddings; and
calculating a local consistency loss using the corresponding overlapped patch embeddings and non-overlapped patch embeddings.

10. The system of claim 9, wherein calculating the local consistency loss using the corresponding overlapped patch embeddings and non-overlapped patch embeddings, comprises calculating a contrastive learning loss and a corresponding matrix matching loss.

11. The system of claim 10, wherein calculating the contrastive learning loss comprises receiving the first and second cropped images at respective student and teacher networks of the self-supervised learning framework, wherein the first cropped image comprises four overlapped patch embeddings that correspond to the patch embedding in the second cropped image, to yield a compositionality-pair of patches that are positive and non-overlapped patches that are negative.

12. The system of claim 11, wherein calculating the corresponding matrix matching loss comprises receiving the first and second cropped images at respective teacher and student networks of the self-supervised learning framework to learn decompositionality for local consistency.

13. The system of claim 12, wherein obtaining the first cropped image and the second overlapping cropped image of the received medical image, each having respective representative global embeddings and corresponding overlapped patch embeddings and non-overlapped patch embeddings, comprises:
organizing the medical image into a two-dimensional grid of image elements (“patches”);
randomly selecting a first plurality of the patches in the two-dimensional grid to obtain the first cropped image;
selecting a second plurality of patches in the two-dimensional grid that overlap, and are a multiple of, the first plurality of patches to obtain the second cropped image; and
resizing the first cropped image and the second cropped image to a same shape.

14. The system of claim 13, wherein obtaining the first cropped image and the second overlapping cropped image of the received medical image, each having respective representative global embeddings and corresponding overlapped patch embeddings and non-overlapped patch embeddings, further comprises:
receiving the resized first and second cropped images at respective student and teacher networks of the self-supervised learning framework and generating respective patch embeddings therefrom;
receiving the respective patch embeddings at respective average pooling operators and generating the respective representative global embeddings therefrom.

15. The system of claim 14, wherein obtaining the first cropped image and the second overlapping cropped image of the received medical image, each having respective representative global embeddings and corresponding overlapped patch embeddings and non-overlapped patch embeddings, further comprises: receiving the respective representative global embeddings at respective student and teacher expanders to expand dimensions of the respective representative global embeddings.

16. The system of claim 15, wherein obtaining the first cropped image and the second overlapping cropped image of the received medical image, each having respective representative global embeddings and corresponding overlapped patch embeddings and non-overlapped patch embeddings, further comprises receiving the expanded representative global embedding from the student expander at a predictor in the student network to the representative global embedding of the teacher network.

17. A method performed by a system having at least a processor and a memory therein to execute instructions to enable a machine learning model to learn anatomical embeddings with global consistency and local consistency from unlabeled data, comprising:
receiving a plurality of unlabeled medical images comprising macroscopic and microscopic anatomical structures that consist of composable/decomposable organs and tissues;
grid-wise image cropping the plurality of medical images to yield two randomly cropped views that have overlaps, thereby reducing the feature irrelevances;
transmitting the two randomly cropped views to a global consistency branch in a student-teacher model; and
mimicking a human understanding of part-whole relationships in the medical images in a local consistency branch of the student-teacher model, where embedding of a whole patch in one branch is consistent with aggregated embedding of all part patches from the other branch.

18. The method of claim 17, wherein mimicking human understanding of part-whole relationships in the medical images comprises simultaneously learning consistent embedding via composition and decomposition with a global consistency branch in a student-teacher model that captures discriminative macro-structures via extracting global features, and a local consistency branch in the student-teacher model that learns fine-grained anatomical details from composable/decomposable patch features via contrastive learning and corresponding matrix matching.

19. The method of claim 17, wherein grid-wise image cropping comprises extracting two overlapping crops from one of the medical images, resulting in a composition pair, CP, comprising a first crop and a second crop, wherein a plurality of patches in the first crop compose a patch in the second crop; and
wherein transmitting the two randomly cropped views to a global consistency branch in a student-teacher model comprises:
transmitting the first crop to a student portion of a student-teacher network of the machine learning model; and
transmitting the second crop to the teacher portion of the student-teacher network of the machine learning model.

20. The method of claim 19, wherein mimicking a human understanding of part-whole relationships in the medical images in a local consistency branch of the student-teacher model comprises learning a local consistency via composition by optimizing a contrastive loss using all CPs as positive pairs and non-overlapped patches as negative pairs and matching loss using a corresponding matrix whose entries are 1s between a patch in the second crop and all its overlapped patches in the first crop and 0s for all non-overlapped patches between the first crop and the second crop.
